(19) United States
(12) Patent Application Publication
(10) Pub. No.: US 2009/0327163 A1
(43) Pub. Date: Dec. 31, 2009

(54) Choice Engine

(76) Inventors: Peter Lawrence Swan, Tamarama (AU); Stuart Dennon, Zetland (AU)

Correspondence Address: FITCH EVEN TABIN & FLANNERY, 120 SOUTH LASALLE STREET, SUITE 1600, CHICAGO, IL, 60603-3406, US

(21) Appl. No.: 12/438,509

(22) PCT Filed: Aug. 21, 2007
(86) PCT No.: PCT/AU2007/001198

§ 371 Date: May 27, 2009

(30) Foreign Application Priority Data
Aug. 21, 2006 (AU) 2006904543

(51) Int. Cl. G06Q 10/00; G06N 5/02

(52) U.S. Cl. 705/400; 706/54

(57) ABSTRACT

Disclosed are arrangements (700) that construct (803) attributes used by a consumer (703) to purchase an item, determine (803) how much of each attribute is contained in each candidate item, estimate (806) marginal costs for the attributes, establish (303) the preferences of the consumer for the various attributes, determine (803) utility scores for the candidate items that reflect the extent to which the candidate items provide the consumer with preferred attributes, and rank the candidate items, in an ordered list, in terms of their respective utility scores.

### FIELD OF THE INVENTION

The present invention relates to on-line databases and to search engines for searching such databases, or more generally for searching over any database where the benefits are enhanced by basing the search on the preferences of the searcher.

### BACKGROUND

With the proliferation of on-line databases, and the consequent increase in the amount of information that is accessible over networks such as the Internet, effective and efficient search mechanisms are becoming increasingly important. Current textual search engines such as Google® perform their search functions using keywords or combinations of keywords. This type of search typically identifies a very large number of results, thus requiring the user to browse through a large number of usually irrelevant choices. Often, items identified using such methods may be not be relevant, let alone optimal, from the perspective of the user.

### SUMMARY

It is an object of the present invention to substantially overcome, or at least ameliorate, one or more disadvantages of existing arrangements. Disclosed are arrangements, referred to as “choice engine” arrangements, which seek to address the above problems by performing one or more of (a) constructing attributes which characterise the tangible and intangible factors used by a typical consumer to choose or purchase an item, (b) estimating attribute scores for candidate items, the attribute scores being a measure of how much of each attribute is contained in each candidate item, (c) estimating “shadow prices” appropriate for these attributes (these reflecting the cost to the consumer of obtaining more of such an attribute), (d) establishing the preferences of a particular consumer for the various attributes, (e) specifying the overall budget constraint for the consumer and an appropriate budget for the item for that particular consumer (i.e. price range or prospective weekly total cost outlay) on an optional basis, (f) determining utility scores for the candidate items (the utility scores providing a measure of the extent to which the candidate items provide the particular consumer with his or her preferred amounts and combinations of the attributes, given the estimated shadow prices that reflect marginal costs to the consumer of the attributes in question and the consumer's overall budget constraint), (g) ranking the candidate items, in an ordered list, in terms of their respective utility scores for that item with the highest ranked item(s) being those having the optimum utility level obtained by maximising utility subject to the expressed preferences, given the estimated shadow prices that reflect marginal costs to the consumer of the attributes in question), (h) selecting the item which provides for the optimal combination and levels of attributes given the consumer's preferences and the estimated shadow prices that reflect marginal costs to the consumer of the attributes in question and overall budget constraint, and, where required, (i), constructing the ask price to assist the seller to achieve a given ranking.

According to a first aspect of the present invention, there is provided a method of identifying a desired item from a set of candidate items each associated with at least one of directly observable factors, and intangible factors that indirectly reflect said directly observable factors, the method comprising the steps of:

constructing, from the associated factors, attributes which characterise the candidate items;

assigning the amount of each attribute preferred by a user;

estimating the amount of each attribute associated with each of the items;

determining the marginal cost of the attributes;

determining the extent to which each candidate item provides the amount of each attribute required by the user; and

constructing a list of at least some of the candidate items in an order that reflects how each said candidate item in the list satisfies the users preferences subject to the assigned preferences of the user, and given the marginal cost of the attributes, wherein the desired item is an item in the ordered list.

According to another aspect of the present invention, there is provided a method of determining an ask price for an item to be sold, said item being an available member of a set of candidate items each associated with at least one of directly observable factors, and intangible factors that indirectly reflect said directly observable factors, the method comprising the steps of:

constructing, from the associated factors, attributes which characterise the set of candidate items;

estimating the amount of each attribute associated with each of the candidate items;

determining the marginal cost of the attributes associated with each of the candidate items;

specifying one of (a) the item to be sold and (b) said at least one of directly observable factors, and intangible factors associated with the item to be sold;

if the item to be sold is specified, determining said at least one of directly observable factors, and intangible factors associated with the item to be sold;

constructing, from the factors associated with the item to be sold, attributes other than ask price which characterise the item to be sold;

specifying (a) a sub-set of the candidate items in regard to which a desired rank is to be determined, and (b) a desired rank of the item to be sold in regard to the specified sub-set;

determining the ask price at which the item to be sold should be offered for sale, dependent upon the constructed attributes which characterise the item to be sold, the specified sub-set of candidate items, the specified rank of the item to be sold, and the extent to which each candidate item provides the amount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.

According to another aspect of the present invention, there is provided an apparatus for identifying a desired item from a set of candidate items each associated with at least one of directly observable factors, and intangible factors that indirectly reflect said directly observable factors, the apparatus comprising:

means for constructing, from the associated factors, attributes which characterise the candidate items;

means for assigning the amount of each attribute preferred by a user;

means for estimating the amount of each attribute associated with each of the items;

means for determining the marginal cost of the attributes;

means for determining the extent to which each candidate item provides the amount of each attribute required by the user; and

means for constructing a list of at least some of the candidate items in an order that reflects how each said candidate item in the list satisfies the users preferences subject to the assigned preferences of the user, and given the marginal cost of the attributes, wherein the desired item is an item in the ordered list.

According to another aspect of the present invention, there is provided an apparatus for determining an ask price for an item to be sold, said item being an available member of a set of candidate items each associated with at least one of directly observable factors, and intangible factors that indirectly reflect said directly observable factors, the apparatus comprising:

means for constructing, from the associated factors, attributes which characterise the set of candidate items;

means for estimating the amount of each attribute associated with each of the candidate items;

means for determining the marginal cost of the attributes associated with each of the candidate items;

means for specifying one of (a) the item to be sold and (b) said at least one of directly observable factors, and intangible factors associated with the item to be sold;

means, if the item to be sold is specified, for determining said at least one of directly observable factors, and intangible factors associated with the item to be sold;

means for constructing, from the factors associated with the item to be sold, attributes other than ask price which characterise the item to be sold;

means for specifying (a) a sub-set of the candidate items in regard to which a desired rank is to be determined, and (b) a desired rank of the item to be sold in regard to the specified sub-set;

means for determining the ask price at which the item to be sold should be offered for sale, dependent upon the constructed attributes which characterise the item to be sold, the specified sub-set of candidate items, the specified rank of the item to be sold, and the extent to which each candidate item provides the amount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.

According to another aspect of the present invention, there is provided an apparatus for identifying a desired item from a set of candidate items each associated with at least one of directly observable factors, and intangible factors that indirectly reflect said directly observable factors, the apparatus comprising:

a memory for storing a program; and

a processor for executing the program, said program comprising:

code for constructing, from the associated factors, attributes which characterise the candidate items;

code for assigning the amount of each attribute preferred by a user;

code for estimating the amount of each attribute associated with each of the items;

code for determining the marginal cost of the attributes;

code for determining the extent to which each candidate item provides the amount of each attribute required by the user; and

code for constructing a list of at least some of the candidate items in an order that reflects how each said candidate item in the list satisfies the users preferences subject to the assigned preferences of the user, and given the marginal cost of the attributes, wherein the desired item is an item in the ordered list.

According to another aspect of the present invention, there is provided an apparatus for determining an ask price for an item to be sold, said item being an available member of a set of candidate items each associated with at least one of directly observable factors, and intangible factors that indirectly reflect said directly observable factors, the apparatus comprising:

a memory for storing a program; and

a processor for executing the program, said program comprising:

code for constructing, from the associated factors, attributes which characterise the set of candidate items;

code for estimating the amount of each attribute associated with each of the candidate items;

code for determining the marginal cost of the attributes associated with each of the candidate items;

code for specifying one of (a) the item to be sold and (b) said at least one of directly observable factors, and intangible factors associated with the item to be sold;

code, if the item to be sold is specified, for determining said at least one of directly observable factors, and intangible factors associated with the item to be sold;

code for constructing, from the factors associated with the item to be sold, attributes other than ask price which characterise the item to be sold;

code for specifying (a) a sub-set of the candidate items in regard to which a desired rank is to be determined, and (b) a desired rank of the item to be sold in regard to the specified sub-set;

code for determining the ask price at which the item to be sold should be offered for sale, dependent upon the constructed attributes which characterise the item to be sold, the specified sub-set of candidate items, the specified rank of the item to be sold, and the extent to which each candidate item provides the amount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.

According to another aspect of the present invention, there is provided a computer program product including a computer readable medium having recorded thereon a computer program for directing a processor to execute a method for identifying a desired item from a set of candidate items each associated with at least one of directly observable factors, and intangible factors that indirectly reflect said directly observable factors, the program comprising:

code for constructing, from the associated factors, attributes which characterise the candidate items;

code for assigning the amount of each attribute preferred by a user;

code for estimating the amount of each attribute associated with each of the items;

code for determining the marginal cost of the attributes;

code for determining the extent to which each candidate item provides the amount of each attribute required by the user; and

code for constructing a list of at least some of the candidate items in an order that reflects how each said candidate item in the list satisfies the users preferences subject to the assigned preferences of the user, and given the marginal cost of the attributes, wherein the desired item is an item in the ordered list.

According to another aspect of the present invention, there is provided a computer program product including a computer readable medium having recorded thereon a computer program for directing a processor to execute a method for determining an ask price for an item to be sold, said item being an available member of a set of candidate items each associated with at least one of directly observable factors, and intangible factors that indirectly reflect said directly observable factors, the program comprising:

code for constructing, from the associated factors, attributes which characterise the set of candidate items;

code for estimating the amount of each attribute associated with each of the candidate items;

code for determining the marginal cost of the attributes associated with each of the candidate items;

code for specifying one of (a) the item to be sold and (b) said at least one of directly observable factors, and intangible factors associated with the item to be sold;

code, if the item to be sold is specified, for determining said at least one of directly observable factors, and intangible factors associated with the item to be sold;

code for constructing, from the factors associated with the item to be sold, attributes other than ask price which characterise the item to be sold;

code for specifying (a) a sub-set of the candidate items in regard to which a desired rank is to be determined, and (b) a desired rank of the item to be sold in regard to the specified sub-set;

code for determining the ask price at which the item to be sold should be offered for sale, dependent upon the constructed attributes which characterise the item to be sold, the specified sub-set of candidate items, the specified rank of the item to be sold, and the extent to which each candidate item provides the a-mount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.

Other aspects of the invention are also disclosed.

### BRIEF DESCRIPTION OF THE DRAWINGS

One or more embodiments of the present invention will now be described with reference to the drawings and Appendices, in which:

FIG. 1 depicts how a consumer typically purchases an item (being a motor vehicle in the described examples) from a population of candidate vehicles;

FIG. 2 depicts a functional block diagram of the disclosed choice engine arrangement being used in a browser-based system;

FIG. 3 depicts elements of the system of FIG. 2 in more detail;

FIG. 4 shows how a user operates the system of FIG. 2;

FIG. 5 shows how the choice server processes a set of user inputs;

FIG. 6 shows a process flow diagram of how the comprehensive choice data can be pre-processed in order to reduce computational complexity;

FIG. 7 shows a process flow diagram of how personal choice data is derived from target feature data;

FIG. 8 shows the step of determining generic comprehensive choice data in FIG. 7 in more detail;

FIG. 9 is a process flow diagram showing the utility scoring step used, for example, in FIG. 7;

Appendix A shows an example of explicit attribute data;

Appendix B shows an example of personal weights and a budget limit relating to an item of interest and the associated attributes; and

Appendix C shows an example of ranked choice data.

Appendix D shows an alternate scoring mechanism approach.

The arrangements described in this description serve merely to illustrate the choice engine, and are not intended to limit the scope of the inventive concept.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

This specification describes one example of how the disclosed choice engine can be applied. This example relates to the situation in which a user is interested in conducting an on-line search to find a motor vehicle which best matches the user's criteria. This example is intended to be illustrative, and it in no way limits the potential applications of the choice engine to other goods and services.

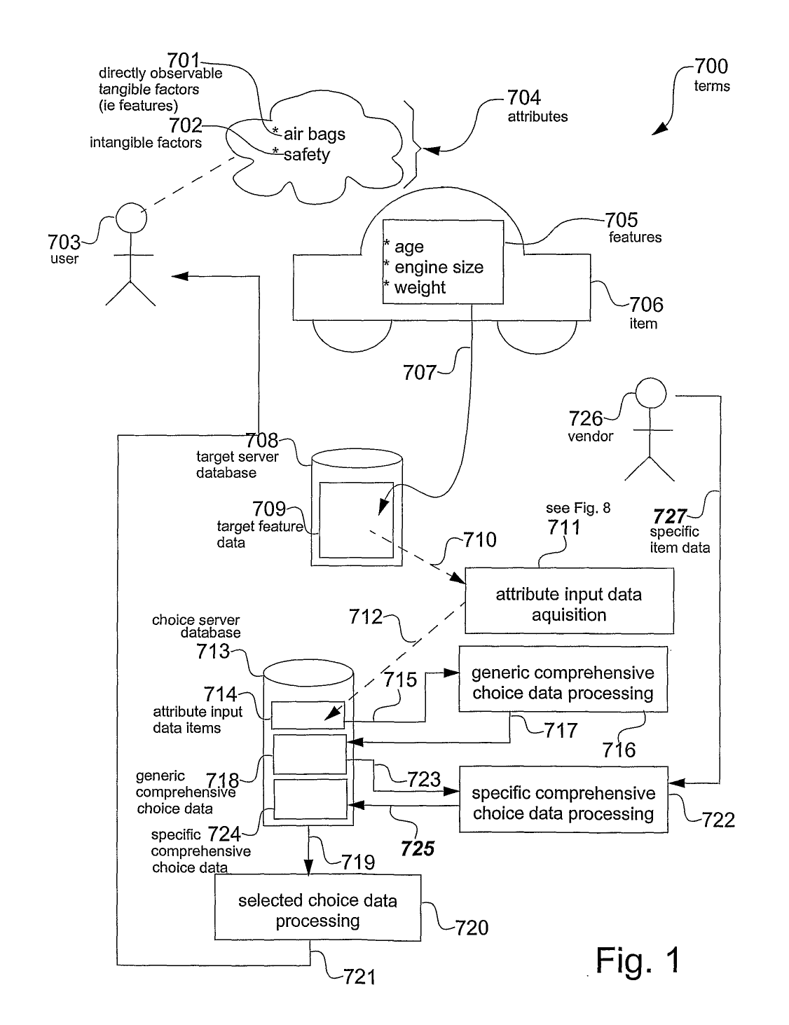

FIG. 1 depicts how a consumer 703 typically purchases an item such as a motor vehicle 706, or makes a bid for a motor vehicle that may result in purchase, from a population of candidate motor vehicles (also referred to as a set of candidate items). The candidate motor vehicles can, in one arrangement, be based upon the Glass Dealer Guide®. This guide includes specifications for all known motor vehicles going back a number of decades. Importantly, the fact that a vehicle is listed in Glass does not mean that such a vehicle is actually available on the market. It may be that such vehicles exist but are not for sale, or even that there are no longer such vehicles in existence. Accordingly, the vehicles listed in Glass are referred to as “candidate vehicles”, while vehicles which have been advertised are referred to as “available vehicles”. If the choice engine arrangements are directed at other applications, the candidate items can be selected from other relevant sets of data. This is based, for each candidate motor vehicle 706, on a consideration of what can be termed ‘internal’ directly observable tangible factors 701 such as, for example, availability of air bags and engine size. The consumer 703 also typically considers other ‘internal’ intangible factors 702 that are implicitly associated with the candidate motor vehicle 706. Such intangible factors 702 can include safety, luxury, performance, environmentally green, and so on, that may indirectly reflect tangible factors such as engine size, power/weight ratio, and so on, that are referred to as ‘internal’ factors. In additional, there is a second category of ‘external’ factors that are aspects of the distribution channel or method which in turn can be divided into tangible and intangible categories. These include the intangible ‘information index’, tangible outlet type, for example, professional dealer or private sale in the case of a motor vehicle, and distributor brand type, eg., well-known reputable distributor, no-name brand etc. Not only does the type of distributor affect the price paid by the user but also the level and quality of service. In addition, disclosure of the name of the distributor may enable certain distributors to build up reputations that convey valuable information to the buyer.

The ‘Information index’ is an index that is created to measure the amount of information included within an advertisement that has been placed (727 in FIG. 1, which is a specific data item) relative to the total amount that can have been given. For example, a score of 1 would mean fall disclosure. Consequently, the Information index is an external attribute that can be used to rank advertisements, allowing the user (703 in FIG. 1) to express preferences over the transparency or opacity of the advertisement itself.

There is also a third category of intangible attribute that is self-reported by the vendor (726 in FIG. 1). A particular example is the Glass, Red Book, or Blue Book Guide Condition Self Assessment—Sellers (and buyers) can fill out a form using rating scales (1=wreck−10=as new) on the items that Glass, Red Book, or Blue Book include in assessing ‘Guide Condition’. This allows sellers to self-assess to assist them in arriving at an ask price. Moreover, buyers who can access the item in (say) a depot of vehicles for sale can also self-assess the item and provide comments on the seller's own self-assessment scores. This also assists buyers in arriving at a bid price and speeds the bargaining process. The self-reported data can be incorporated into the system of FIG. 1 in a number of ways. In one example, the self-reported data is one type of target feature data 709 and thus resides on a target server database 708. This information is accessed in the same manner as any other target feature data as depicted by the arrow 710.

The aforementioned factors (also referred to as factor data), including both directly observable factors 701 and intangible factors 702, are referred to in this description as “attributes” 704. The attributes 704 thus characterise the candidate motor vehicles of interest 706. Directly observable factors 701 such as engine size, the presence or absence of airbags, and so on, are also referred to as “features” 705. The features 705 associated with the depicted vehicle 706 are typically stored as “target feature data” 709 by various parties, as depicted by an arrow 707, in “target server databases” 708.

In addition to technical features such as the presence of air bags, features such as the “asking” price for a vehicle, and actual prices at which vehicles are traded, are also stored as target data 709 in the target server databases 708.

The disclosed choice engine arrangements acquire, as depicted by a process 711 and a dashed arrow 710, selected target data 709 and store this data, as depicted by a dashed arrow 712, as “attribute input data items” 714 in a “choice server database” 713. The attribute input data items comprise, for the case where the choice engine arrangements are used by the user to select motor vehicles, features such as make, model, odometer reading, presence or absence of air bags, motor magazine opinions on safety, asked or actual prices of vehicles, and other directly observable factors stored in the target server database 708.

In an alternative application the target database can consist of (say) newspaper stories and the constructed subjective attributes can be scores for themes such as business, current affairs, crime, sport, celebrity, gossip, politics, scandal, analysis, etc for each news story.

The choice engine arrangements process the attribute input data items 714, as depicted by an arrow 715 and a process 716, to produce generic comprehensive choice data 718 which is stored in the database 713. The generic comprehensive choice data 718 relates to typical motor vehicles such as a typical 1990 Toyota Camry®. The generic comprehensive choice data 718 thus includes, but is not limited to, attributes which are relevant to consumer preferences in selecting motor vehicles, shadow prices associated with these attributes, attribute scores for the typical vehicles, these scores representing the estimated amount of each attribute that is embodied in the typical vehicle, and so on.

The choice engine arrangements receive specific item data 727, which in the example of FIG. 1 is provided by a vendor 726 of motor vehicles. The specific item data can be provided, for example, in the form of advertisements for specific motor vehicles which are currently available. The choice engine arrangements process the generic comprehensive choice data items 718 using the specific item data 727, as depicted by an arrow 723 and a process 722, to produce specific comprehensive choice data 724 which is stored in the database 713. The specific comprehensive choice data 724 relates, for example, to a particular 1990 Toyota Camry® owned by Mr Smith, and specified in an advertisement in the specific item data 727. This vehicle clearly has a specific odometer reading and other specific features. The specific comprehensive choice data 724 includes, but is not limited to attribute scores for the specific vehicle in question.

In one arrangement, the step 722 derives the specific comprehensive choice data 724 from the generic comprehensive choice data items 718 by searching the generic comprehensive choice data items 718 to for a match to the specific item data 727. This match, be it exact or approximate to within predefined margins, produces the specific comprehensive choice data 724.

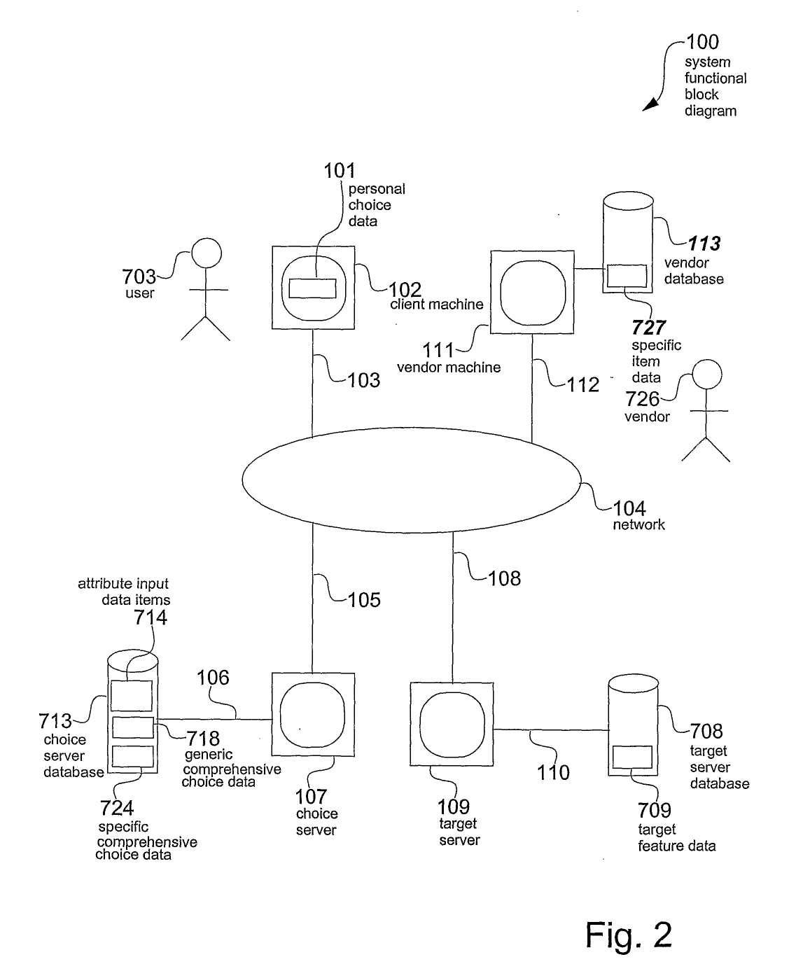

The user 703 provides his or her product or service specifications to the choice engine arrangement, whereupon a process 720 operates upon the specific comprehensive choice data 724, to provide, as depicted by an arrow 721, “personal choice data” 101 (see FIG. 2) to the user 703. This personal choice data is presented, in the described arrangements, as a list of specific vehicles ranked in terms of their ability to provide the consumer with his or her preferred amounts of the attributes. (In some choice engine arrangements, a list of candidate vehicles as well as or instead of the list of specific vehicles, ranked in terms of their ability to provide the consumer with his or her preferred amounts of the attributes, can also be presented to the user.) This list of ranked vehicles can be based upon a predefined item budget (in this example being the per-period outlay on the vehicle or budget range which the consumer has specified) but this is optional. For the same outlay, any other motor vehicle involving different attribute levels will be inferior. Typically, the asking price, or at least prospective purchase price, lies at or within some motor vehicle budget if it is provided by the user, whether the budget is expressed in terms of the prospective outlay on that motor vehicle or the equivalent per period cost of owning and operating such a motor vehicle.

The user may choose not to provide a budget range as it is not strictly necessary. Lowering his or her or personal preference scores for attributes will result in the choice engine ranking particular motor vehicles much higher on the ranking scale that can provide preferred attributes at relatively low cost. Typically, these motor vehicles will be cheaper. If the list presented to the user includes vehicles that are too expensive to be considered by the user, a price filter can eliminate these otherwise optimal choices.

The terms features, factors, and attributes have varying meanings in this description, and the specific meaning can be determined from the context.

A number of terms are used in this description, and some of these are defined in the following Glossary of Terms.

### Glossary of Terms

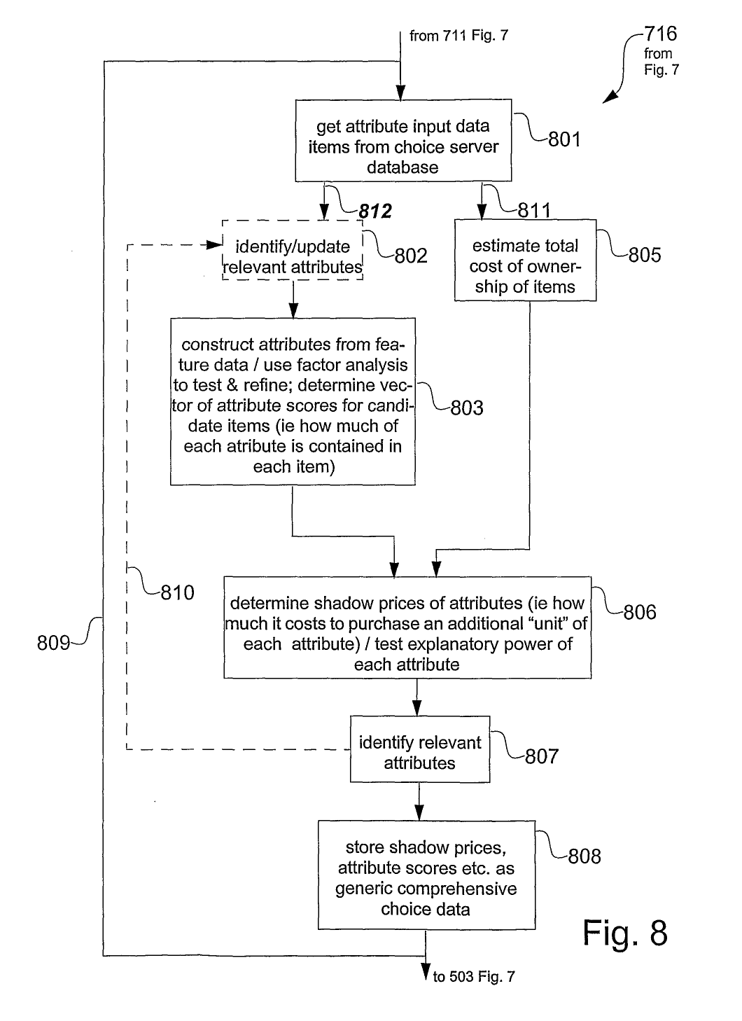

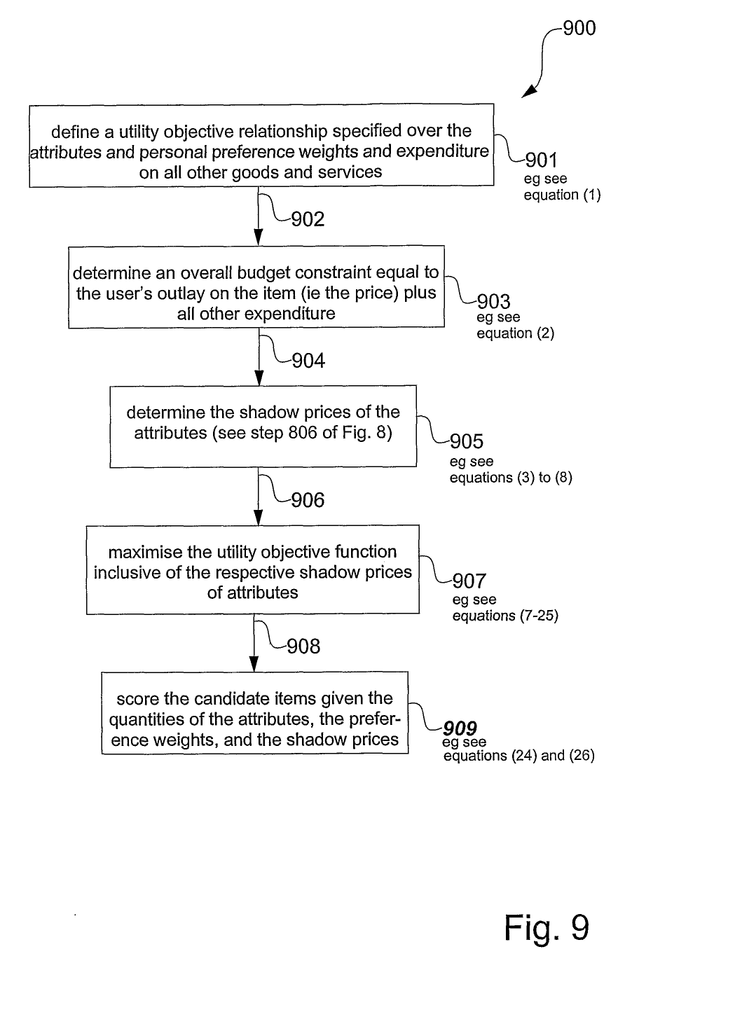

User: (eg 703) the person, eg the consumer 703, using the disclosed choice engine arrangements to find the “best” available motor vehicle (in the present example);
Feature: (eg 705) a directly observable part, characteristic, magazine opinion, or component fitted to or associated with a good or service. For example, in the case of a vehicle, features include the presence or absence of air conditioning, power assisted steering, and so on, as well as the odometer reading, and age of the vehicle. The asking price would also typically be available from the website or classified advertisement.
Attribute: (eg. 704) a characteristic quality of an item, which may or may not be directly observable, that is perceived to be important by the user. Some directly observable features, such as engine size, may be attributes in the eyes of potential purchasers of sports cars. Other attributes, such as safety, luxury, performance, and so on, are implicit qualities that arise out of the presence or absence of specific features. For example, vehicles having features such as anti-lock brake systems (ABS), driver and passenger air bag and so on can be said, by virtue of being fitted with such features, to have a certain measure of “safety”. These tangible and intangible attributes are termed ‘internal’ as they are directly associated with attributes of the item in question. There is also a second category of attributes called ‘external’ attributes associated with the way in which the item is portrayed by the seller, for example, the amount of information provided, and the distribution mechanism. A related category is information provided by the seller on, for example, the condition of a vehicle.
Attribute input data items: (eg. 714) information about features of the item 705 that are stored in the choice server database 713.
Target data: (eg 709) data that is stored in third party databases such as 708 that are associated with target servers, the target data relating to features of the items in question. This data typically includes the asking price for a vehicle in a classified advertisement, new and second-hand prices from Glass® or similar sources, and actual exchange prices of vehicles from databases provided by auction houses, car dealers and the like;
Generic Comprehensive choice data: (eg. 718) information that is derived, according to a process shown, for example, in FIG. 8, from the target data 709 and which relates to typical motor vehicles (for the present example) such as “1990 Toyota Camry®” vehicles;
Specific Comprehensive choice data: (eg. 724) information that is derived, according to a process shown, for example, in FIG. 8, from the Generic Comprehensive choice data 718 when, for example, it is matched against specific item data 727 (see FIG. 1) and which relates to specific (actual) motor vehicles (for the present example) such as “the 1990 Toyota Camry® belonging to Mr Smith and advertised by the vendor 726 in the specific item data 727”;
Personal choice data: (eg. 101) information that is derived by processing the specific comprehensive choice data 724 according to preferences input by the user 703.
Overall budget constraint: (eg. FIG. 9) this constraint represents the user's total possible outlay on all goods and services including the specific item (motor vehicle in the example). While this amount is conceptually known to the user, this information is not required by the choice engine and is thus not requested as an input by the choice engine.
Shadow Price: (eg FIG. 9 Step 905) the estimated relationship between either the price of an item or the outlays per unit of time and the quantity measure for an attribute. It represents the estimated marginal cost to the choice engine user of an increment to an attribute.

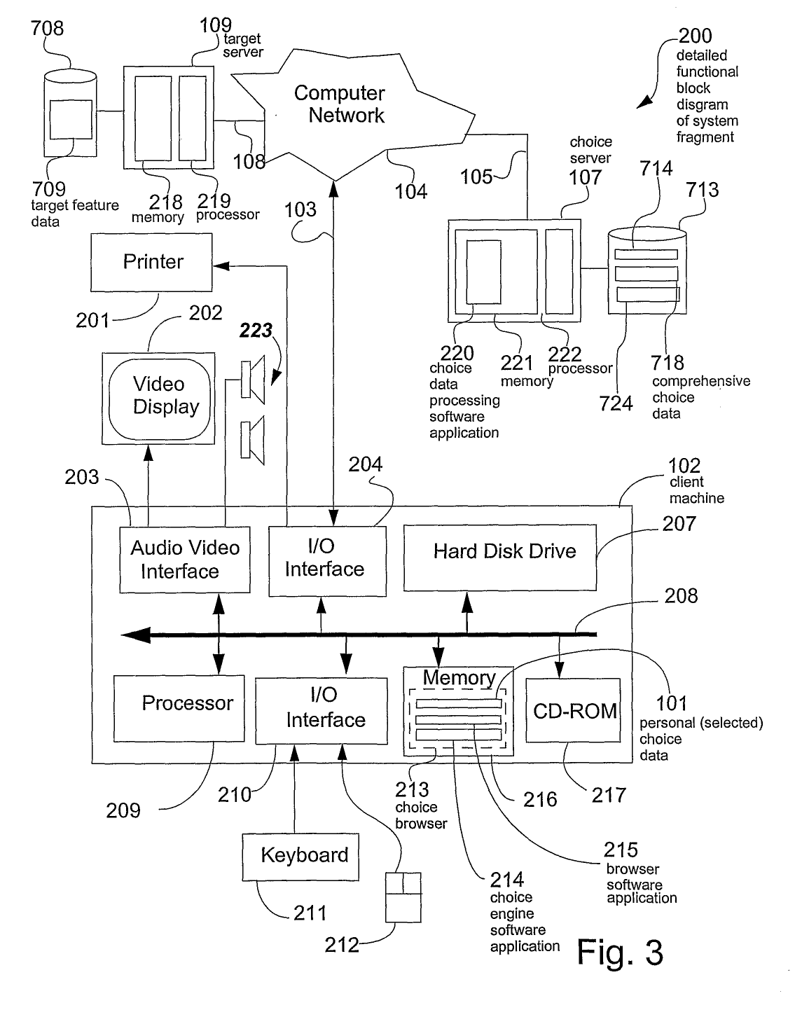

FIG. 2 depicts a functional block diagram 100 of the disclosed choice engine arrangement being used in a browser based database search system comprising a number of machines (102, 111, 107 and 109) operating in a distributed fashion over a network 104. The user 703 uses the client machine 102 to obtain the selected choice data 101 over the network 104. The client machine 102 is connected to the network 104 via a connection 103. The choice server 107 runs a choice data processing software application 220 (see FIG. 3) in order to retrieve, from the target data 709 that is stored in one or more target server databases 708, the attribute input data items 714 that are then stored in the choice database 713. The choice server 107 processes the attribute input data items 714 to produce the generic comprehensive choice data 718.

The vendor machine 111 is connected to the network 104 by a connection 112, and has an associated vendor database 113 which stores the specific item data 727. In one example, the vendor machine 111 is operated by a newspaper which runs advertisements for motor vehicle sales. In this example, the specific item data 727 is the motor vehicle advertisements. The choice server 107 processes the generic comprehensive choice data 718, using the specific item data 727, to produce the specific comprehensive choice data 724. The choice server database 713 is connected to the choice server 107 by a connection 106. The choice server 107 is connected to the network 104 by a connection 105.

In another example, the vendor machine 111 is operated by a newspaper which runs advertisements for motor vehicle sales. The choice server 107 processes the generic comprehensive choice data 718, using the specific item data 727, to produce the specific comprehensive choice data 724, as in the previous example. In this present example however the choice server additionally processes and scores the generic comprehensive choice data 718 using indicative prices from sources such as Glass Dealer Guide® and the consumer's indicated preferences without reference to the specific item data 727 (such as an actual advertisement for an actual vehicle). The purpose of scoring generic items 718, when there is no equivalent specific item 727 (as is the case if that particular vehicle is not currently being advertised), is to elucidate the consumer's preferences for generic motor vehicles relative to specific motor vehicles available to the consumer. Should the consumer express a preference for a generic motor vehicle relative to specific motor vehicles, then a mechanism is set in motion which generates a ‘motor vehicle wanted’ advertisement (this being a specific example of a more general “request for specific item” that is generated in regard to the situation in which no specific item 727 is currently available) that is sent to potential suppliers of the generic motor vehicle, for example, a professional seller of new or used vehicles. In other words, if the user 703 expresses a desire for a particular motor vehicle which is presently not being advertised (ie., there is no corresponding specific data item 727), then relevant information can be provided to the vendor machine 111 that is operated by the newspaper to enable that newspaper to run the “vehicle wanted” advertisement for the specific vehicle that is desired by the user.

The client machine 102 runs a choice browser 213 (see FIG. 3) that, possibly in cooperation with the choice data processing software application 220, derives the selected personal choice data 101 from the specific comprehensive choice data 724. The choice server 107 running the choice data processing software application 220 retrieves the attribute input data items 714 from the target data 709 that is stored by one or more target servers 109 in their associated target server databases 708. The target server 109 is connected to the target server database 708 by a connection 110.

The target server 109 is connected to the network 104 by a connection 108. The target data 709 is typically feature data 705 that is processed by the choice data processing software application 220 to derive the attribute input data items 714.

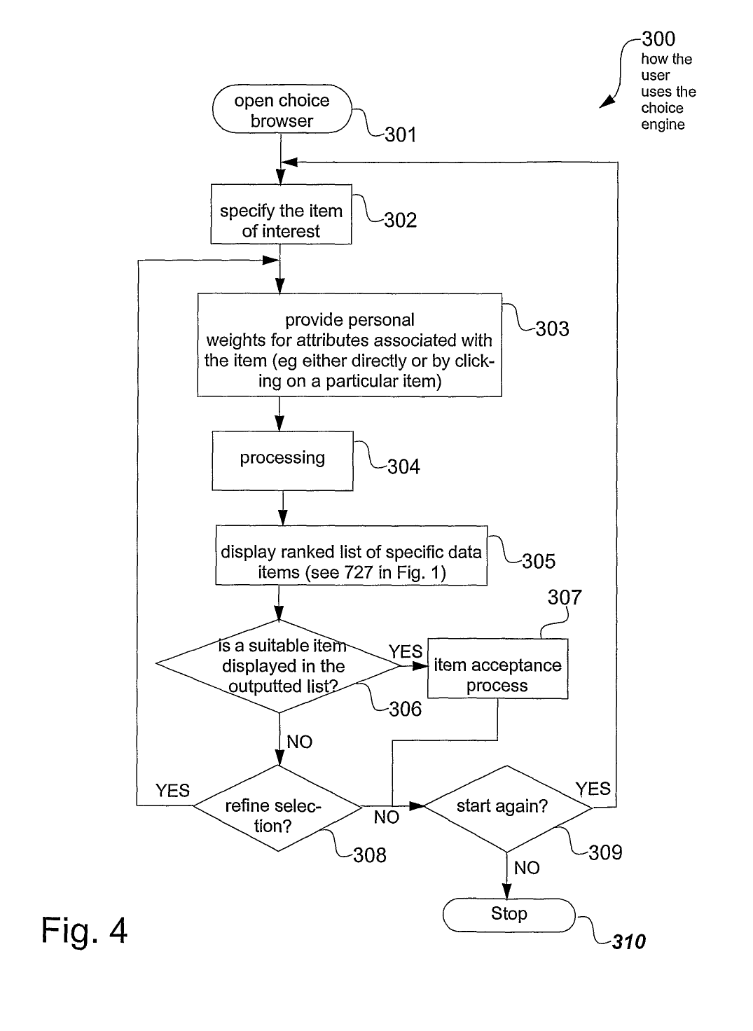

FIG. 3 depicts elements of the system in FIG. 2 in more detail. FIG. 3 shows the client machine 102 in some detail, and shows the choice server 107 and the target server 109 in somewhat less detail. In one arrangement, all the machines 102, 107 and 109 are general-purpose computers, which cooperate to effect an advantageous choice engine system 200 upon which the disclosed choice engine methods can be practiced. The choice engine processes of FIGS. 4-9 may be implemented as software, such as application programs 220 and 213 executing within the computer system 200. In particular, the choice engine method steps are effected by instructions in the software that are carried out by the computers 102, 107 and 109. The instructions may be formed as one or more code modules, each for performing one or more particular tasks. Each of the software applications, such as 220 and 213, can also be divided into two separate parts, in which a first part performs the choice engine methods and a second part manages a user interface between the first part and the user.

The choice browser software application 213 can be implemented, as depicted in FIG. 3, as a conventional browser application 215 complemented by an ancillary choice browser application 214. The choice engine application 214, the conventional browser application 215, and the personal choice data 101 cooperate in the choice browser application 213 in the present example. Other software architectures can also be used.

The software modules may be stored in a computer readable medium, including the storage devices described below, for example. The software is loaded into the computers from the computer readable medium, and then executed by the computers. A computer readable medium having such software or computer program recorded on it is referred to as a computer program product. The use of the computer program product in the computers preferably effects an advantageous system for effecting the disclosed choice engine arrangements.

The client machine 102 is formed by input devices such as a keyboard 211 and a mouse 212, and output devices including a printer 201 a display, device 202 and loudspeakers 223. A Modulator-Demodulator (Modem) transceiver device (not shown) is incorporated into an I/O interface 204 for use by the client machine 102 for communicating to and from the choice server 107 and the one or more target servers 109 over the communications network 104. The aforementioned communication can be effected over the Internet and other networks such as Local Area Networks (LANs) or Wide Area Networks (WANs).

The choice server 107 has a similar architecture to that of the client machine 102 in the present example, however for ease of explanation, FIG. 3 only shows a choice server processor 222, a memory 221 and the choice data processing software application 220 running on the choice server 107. The target server 109 has a similar architecture to that of the client machine 102 in the present example, however for ease of explanation FIG. 3 only shows a target server processor 219, and a memory 218.

The client machine 102 typically includes at least one processor unit 209, and a memory unit 216, for example formed from semiconductor random access memory (RAM) and read only memory (ROM). The client machine 102 also includes a number of input/output (I/O) interfaces including an audio-video interface 203 that couples to the display 202 and the loudspeakers 223, an I/O interface 210 for the keyboard 211 and the mouse 212, and the interface 204, incorporating the modem, for the printer 201.

A hard disk drive 207 is typically provided, as is a CD-ROM drive 217. The components 203, 204, 207, 209, 210, 216 and 217 of the client machine 102 typically communicate via an interconnected bus 208 and in a manner that results in a conventional mode of operation of the interconnected computer system 200 known to those in the relevant art. Examples of computers on which the described arrangements can be practised include IBM-PC's and compatibles, Sun Sparcstations or like computer systems evolved there-from.

Typically, the choice browser application program 213 is resident on the hard disk drive 207 and read and controlled in its execution by the processor 209. Intermediate storage of the program 213 and any data fetched over the network 104 may be accomplished using the semiconductor memory 216, possibly in concert with the hard disk drive 207. In some instances, the choice browser application program 213 may be supplied to the user 703 encoded on a CD-ROM and read via the corresponding drive 217, or alternatively may be read by the client machine 102 from another source over the network 104. Still further, the software 213 can also be loaded into the client machine 102 from other computer readable media.

The term “computer readable medium” as used herein refers to any storage or transmission medium that participates in providing instructions and/or data to the choice engine system 200 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 102. Examples of transmission media include radio or infra-red transmission channels as well as a network connection to another computer or networked device, and the Internet or Intranets including e-mail transmissions and information recorded on Websites and the like. The aforementioned of downloading the choice browser software application 213 into the client machine 102 applies equivalently to downloading the choice data processing software application 220 onto the choice server 107.

The choice engine methods may alternatively be implemented in dedicated hardware such as one or more integrated circuits performing the functions or sub functions of the choice engine. Such dedicated hardware may include graphic processors, digital signal processors, or one or more microprocessors and associated memories.

FIG. 4 shows a flow chart of a process 300 by which the user 703 operates the choice engine system 100 of FIG. 2 to achieve an advantageous selection of a motor vehicle. The process 300 commences with a step 301 in which the user 703 executes the choice browser software application 213 by providing suitable commands to his client machine 102 via the associated keyboard 211 and/or mouse 212 (see FIG. 3). In a following step 302 the user 703 specifies the vehicle of interest, which in the present example is the motor vehicle 706 (see FIG. 1). In a following step 303 the user provides scores (i.e., weights or coefficients for various attributes), associated with the vehicle 706, thereby assigning their user preferences to the attributes. In some choice engine arrangements, these weights can be retained and used by other users of the choice engine arrangement. These scores can represent linear coefficients for a consumer with preferences specified in a ‘quadratic’ manner with other coefficients that are negative and express how rapidly utility diminishes in the square of the quantity of each attribute consumed. However, other variants are also possible. In another variant at least, these weights can be thought of as the proportions of the consumers overall budget for that item that he or she would like to place on each attribute. This variant is developed in greater detail in Appendix D.

Since this preference weight exceeds the associated 'shadow price’ (ie., marginal cost) estimate for that attribute for it to contribute to the user's utility, there is an effective lower bound to this score given by the shadow price of the motor vehicle 707 with the lowest shadow price for that attribute. Thus suppose that for a particular user the preference weight for (say) safety is $1,000 but for one motor vehicle the shadow price of safety is $600. This user will gain a $400 benefit from choosing this vehicle from the perspective of safety. However, a more expensive motor vehicle may have a shadow price of safety of $1200 leaving the user with a potential negative benefit of $1,000 minus $1,200 or minus $200. This user would not choose the more expensive vehicle from the perspective of safety, and hence the minimum benefit from safety is set at zero rather than minus $200 for this vehicle.

In another variant of the step 303, the user may express weights or scores by simply indicating the sort of vehicle that the user likes, by choosing a particular vehicle from a list of vehicles. Alternately, the user can indicate a preference for one of the generic or specific data vehicles such as an advertisement for a particular make and model of vehicle. The choice engine can then generate the personal preference weights that would result in selection of the preferred vehicle. These generated weights can then be used to rank all available motor vehicles.

For example, Mr. Smith may, using the choice engine, express a preference for a Ferrari® model which he cannot afford to purchase. Independently, that Ferrari® vehicle may be identified as the optimum vehicle for Mr. Jones, who ranked both performance and safety highly, assuming that these are the relevant attributes for a Ferrari®. Mr. Smith can thus make use of the outcome of Mr. Jones preferences (ie., identification of the Ferrari® vehicle and the inference of Mr Jones preferences from this choice) to rank all vehicles, including cheaper ones, in terms of performance and safety.

Under one variant the expenditure on each attribute for that user's choice can be interpreted as the product of an estimated ‘shadow price’ (ie., marginal cost) for that attribute, and a quantity of that attribute, such that the sum of the various attribute outlays equals the price, (ie., budget or outlay) for that vehicle for that user plus a coefficient representing the “unexplained” component of either the price of the vehicle or the weekly cost. In this arrangement the vehicle consists of a bundle of the specified attributes plus unspecified attributes captured by an intercept or constant term, and a “residual” from an estimated regression “explaining” prices or budgets. However, such a linear system of notional outlays on the various attributes making up the item in question is not the only possible specification. A variety of other arrangements including non-linear specifications and the inclusion of multiplicative or “interaction” terms is also possible.

In one arrangement, the choice engine system 100 assists the user 703 in his or her interaction with the choice browser 213 by presenting, in regard to the step 302, a list of vehicles on the video display 202 from which the user 703 can pick a specified vehicle. This list can, for example, be a hierarchical list of products including, medical insurance products, home mortgages, general insurance, furniture, real estate, motor vehicles and so on. In fact, any product or service for which data can be obtained.

In regard to the following step 303, once the user has specified a motor vehicle in the step 302, the choice engine system can display in one arrangement, on the video display 202, a number of alternatives sets of weights, or scores, from which the user 703 selects a particular set. This might be applicable if the user is only interested in certain attributes of the specified vehicle and wishes to ignore other attributes of the vehicle. For example, Mr Smith might only be interested in the performance and safety aspects of a Ferrari® if that is the vehicle he nominates. Whereas in fact there may be many other attributes of a Ferrari® that some other user such as Mr Jones cares about. Alternately, or in addition, the choice engine system can present a number of motor vehicles that implicitly embody sets of weights or scores, from which the user selects one vehicle.

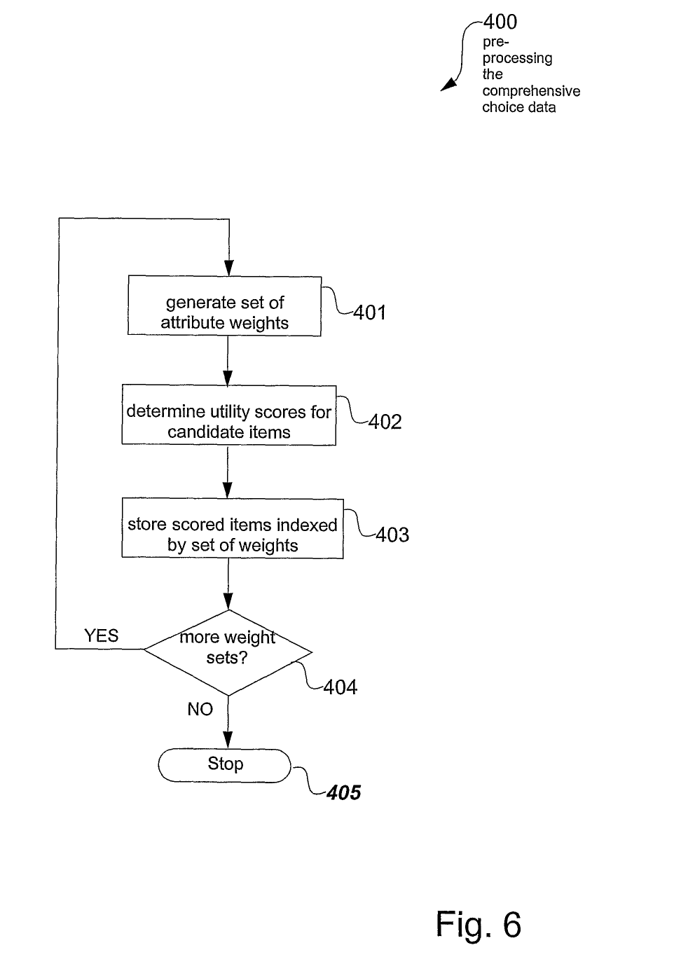

In this manner, the choice engine system can restrict the number of customised permutations that the user can select, thereby placing a limit on the required computation complexity of the system. This is referred to as the comprehensive choice data pre-processing approach, and is described in more detail in relation to FIG. 6.

The user can also specify how much outlay per-time-period he or she wishes to spend on the vehicle or specify which of various pre-set budget or price ranges is appropriate for him or her. As a variant on this the price range for the vehicle in which he or she is interested and he or she has specified can be converted to a budget range per unit of time period. The specification of an outlay or budget range by the user is optional as the willingness of the user to specify either high or low personal attribute scores relative to the shadow prices of these attributes will determine whether or not the choice engine returns relatively expensive or cheaper vehicles in the ranking order.

In another variant of the step 303, the score can be expressed as the margin above the estimated “shadow price” of that attribute associated with the vehicle 706, thereby assigning their user preferences to the attributes in a manner which is proportionate to the estimated shadow price. Thus, for example, the user may place a score of a 30% margin (0.3) above the shadow price on the attribute of safety, a score of a 60% margin (0.6) above the shadow price of the attribute ‘performance’, and other scores on other attributes. While this variant may in some cases make it easier to elicit information on the user's preferences, it is not generally recommended as it may mean that variations in the estimated shadow prices are not fully reflected in the overall utility scores computed for a variety of vehicles with different shadow prices of attributes. Another problem with such a simple scoring method is that it implies that the user values attributes provided by expensive motor vehicles at high marginal cost as highly, if not more highly, than by more economical vehicles that can provide attributes with lower shadow prices.

Once the user has provided the necessary information to the system in the step 303, the choice server 107, running the choice data processing software application 220, processes, in a following step 304, the generic comprehensive choice data 718 using the user information to derive utility scores for a population of candidate motor vehicles. Even when there is no candidate motor vehicle such as an advertisement corresponding to a particular member of the generic comprehensive choice data 718, in one variant at least the generic vehicle can be scored in place of the missing candidate vehicle, giving rise to a ‘want’ advertisement should the generic vehicle outscore the available candidate motor vehicles. This is described in more detail in the section entitled “Utility Scoring”. Once this processing step 304 is completed, the choice server 107 displays, in a following step 305 on the video display 202 of the client machine 102, a ranked list of motor vehicles which reflect, in descending order of optimality, the vehicles in order of their corresponding utility scores.

In some applications, in which vehicle advertisements including Online Classified Advertisements (OCAs) are scored directly, the ranked list of advertisements may be displayed. In at least one alternative application, ranked advertisements can be displayed along with ranked “latent advertisements”, based on generic choice data for actual or potential vehicles that were not advertised for which there was no specific choice vehicle data, but which may potentially be superior. Expressing a preference for one of these scored generic vehicles can generate a “want” advertisement directed at a prospective seller.

Accordingly, in the present arrangement, the user is, in the step 305, presented with a ranked list of vehicle advertisements that are found to satisfy his requirements. The information presented may include the price or budget range (which the user may have specified in the step 303, in one arrangement), and may include multiple advertisements for similar makes, models and vehicle ages, and/or vehicles having similar odometer readings.

When similar vehicles, with consequently similar utility scores (but typically with vehicles with lower “ask” prices ranked more highly) are presented, advertisements with independent evidence of good vehicle condition are ranked higher than vehicles without these advantages. Thus, for example, vehicles carrying certificates of either mechanical or visual expert assessment, eg by the National Roads and Motorists Association (NRMA®), typically rank higher in the list. Moreover, vehicles with a higher self-reported condition ranking will be ranked higher if the user specifies the condition of the vehicle as something her or she cares about.

In a following step 306 the user 703 determines if a suitable motor vehicle has been displayed, and if this is the case, as indicated by the user via the keyboard 211 and/or the mouse 212, then the process 300 follows a YES arrow from the step 306 to a step 307 which performs an motor vehicle acceptance process. In a more comprehensive specification involving the scoring of generic motor vehicles, when an equivalent specific motor vehicle is not available, the user may proceed to the step 307 which also performs a motor vehicle acceptance process when a generic motor vehicle is chosen in place of a specific motor vehicle. However, in this case a ‘want’ advertisement may be sent to a prospective supplier as there is currently no ‘actual’ supplier or advertiser.

The motor vehicle acceptance process 307 can involve direct email contact between the user 703 and the vendor (or prospective vendor in the case of a ‘want’ advertisement), such as 726, associated with the selected motor vehicle. On the other hand, the motor vehicle acceptance process 307 can be implemented using other mechanisms such as on-line auctions.

Once the motor vehicle acceptance process 307 has been completed, the process 300 is directed to a step 309 in which the user 703 is offered the opportunity to search for a new motor vehicle using the choice engine system 100. If the user 703 elects to do so, then the process 300 follows a YES arrow from the step 309 back to the step 302. If, on the other hand, the user elects to terminate the choice selection process 300, then the process 300 follows a NO arrow from the step 309 to a STOP step 310.

Returning to the step 306, if a suitable motor vehicle is not displayed on the outputted list on the video display 202, then the process 300 follows a NO arrow from the step 306 to a step 308. In the step 308 the choice browser 213 offers the user 703 the opportunity to refine their selection by adjusting the weights provided by the user in the step 303 or implicitly adjusting the weights by choosing to base the weights on another displayed motor vehicle.

The user can also be offered the opportunity to vary the weights up or down by some specified percentage in respect of the motor vehicle that he or she initially chose as the motor vehicle on which to base the weights. For example, if the user initially chose as the aspirational vehicle the highest performing Ferrari® model, then if more performance is required, the user can elect to raise this score by 10%.

If the user elects the refinement option, then the process 300 follows a YES arrow from the step 308 back to the step 303. If, on the other hand, the user 703 elects to terminate the present choice process 300, then the process 300 follows a NO arrow from the step 308 to the step 309.

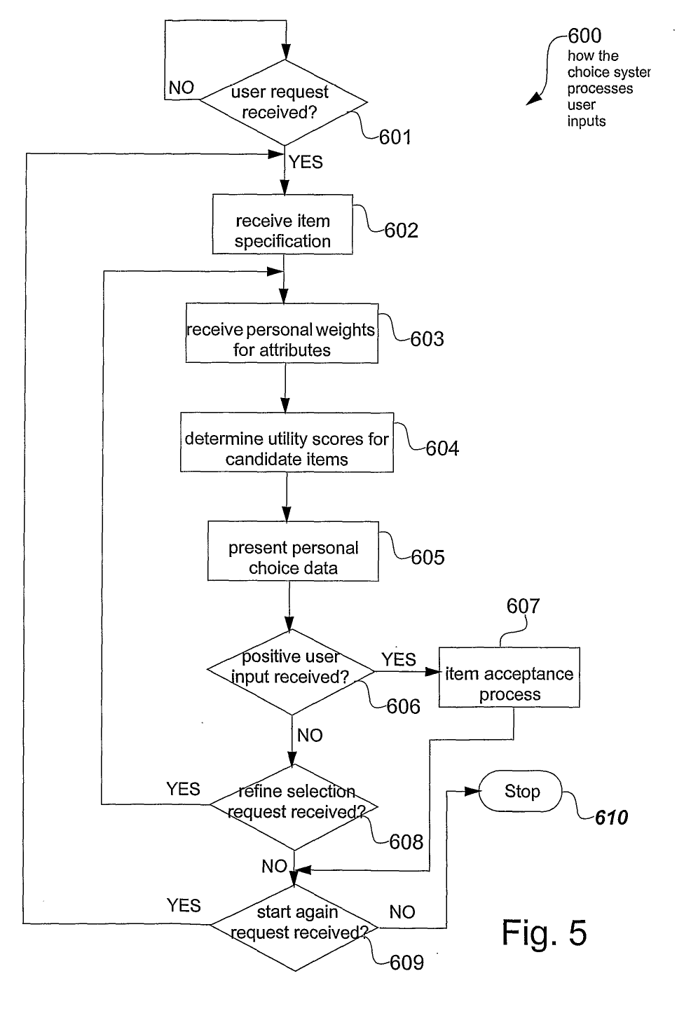

FIG. 5 shows a process 600 of how the choice system 200 processes user inputs that have been provided by the step 303 in the process 300 in FIG. 4. The process 600 commences with a step 601 in which the choice server 107 determines if a request from the user 703 has been received. If this is not the case, then the process 600 follows a NO arrow in a looping fashion from the step 601 back to the step 601. If, on the other hand, a request from the user 703 has been received, then the process 600 follows a YES arrow from the step 601 to a step 602. In the step 602 the choice server 107 receives a specification of the motor vehicle of interest as provided in the step 302 in FIG. 4. In other words, in the step 602 the choice server 107 is informed that the user 703 is interested in motor vehicles. Thereafter, in a step 603, the choice server 108 receives the personal weights provided by the user according to the step 303 in FIG. 4.

If the specific comprehensive choice data 724 has been pre-processed (see FIG. 6), then in a subsequent step 604, the choice server 107 searches the pre-processed specific comprehensive choice data 724 in the choice server database 713 using the personal weights received from the user in the step 603 as an index.

Thereafter, in a step 605, the choice server 107 presents the resultant personal choice data in the form of a ranked list, in order of the utility score of each listed motor vehicle, on the display 202 (see 305 in FIG. 4). In a following step 606 the choice server 107 determines if the user 703 has provided a positive input, indicating acceptance of one of the displayed motor vehicles. If this is the case, then the process 600 follows a YES arrow from the step 606 to a step 607. The step 607 constitutes a motor vehicle acceptance process as previously described in relation to the step 307 in FIG. 4. Thereafter, the process 600 is directed to a step 609 in which the choice server 107 determines if the user wishes to commence a new choice selection. If a “start again” request has been received, then the process 600 follows a YES arrow from the step 609 back to the step 602. If, on the other hand, the user does not wish to commence a new choice search, then the process 600 follows a NO arrow from the step 609 to a STOP step 610.

Returning to the step 606 if a positive user input is not received, indicating that the user in the step 304 in FIG. 4 has not found a suitable motor vehicle in the displayed ranked list, then the process 600 follows a NO arrow from the step 606 to a step 608. In the step 608 the choice server 107 determines if the user wishes to refine their selection criteria, as determined by the step 303 in FIG. 4. If this is the case, then the process 600 follows a YES arrow from the step 608 back to the step 603. If, on the other hand, the user does not wish to refine their selection, then the process 600 follows a NO arrow from the step 608 to the step 609.

FIG. 6 shows a process 400 of how the specific comprehensive choice data 724 can be pre-processed in order to reduce the computational complexity of the disclosed choice engine arrangements, thereby improving the speed of response of the system. The process 400 commences with a step 401 in which the choice server 107 generates a set of attribute weights.

It is noted that the attribute weights described in the present example can take more complex forms than simple linear dollar value amounts that can be compared with the estimated “shadow” prices of each attribute of each item to reflect the preferences of the user. A higher benefit level than the shadow price estimate for the attribute ‘safety’ for a particular vehicle would mean that this attribute provides a net benefit (surplus) to that user. Thus the higher the personal preference weight for (say) ‘safety’ the more likely it is that more expensive vehicles that provide higher safety but at a greater cost (shadow price) will be ranked highly. Apart from taking a linear form, these benefit (ie., preference) indicators can also take other forms such as non-linear forms. Consumer preferences can also be inferred, by the user indicating an aspirational item such as a desired vehicle. This method is elaborated in more detail in the section below on utility scoring.

In fact any preference relationship that ensures that the users ‘utility’ is at a maximum when defined over attributes, when the estimated costs of supplying these attributes can be taken into account, can be used. Moreover, the scoring system does not necessarily even require shadow price estimates at all if it is not practicable or even relevant to compute such estimates. For example, if themes from (say) newspaper articles are scored as attributes, but the cost of accessing all newspaper stories is the same, then no purpose is served by attempting to compute shadow prices. Users may still need to provide their personal preference weights and then the utility scoring mechanism can still operate in the same manner with all the shadow prices set to zero.

Other more sophisticated preference relationships can be used involving possibly fractional or higher powers and multiplicative interaction terms, even though these tend to be more complex. It is still possible to optimise with respect to consumer choices with such greater complexity so long as an optimum exists. Under some circumstances an implicit rather than explicit solution is found to the consumer's optimising problem but it is still possible to apply the choice engine approach under these more general conditions.

Returning to the present example, the weights generated in the step 401 by the choice server 107 belong to a pre-defined set of permitted customisation weight permutations. In a following step 402 the choice server 107 determines utility scores for the candidate motor vehicles in the motor vehicle class being considered.

As will be described in more detail in regard to FIG. 8, the step 402 determines, for each candidate motor vehicle, the utility score for the bundle of attributes characterising the motor vehicle which is optimal from the perspective of the user 103. The utility score is constructed utilizing the preference scores and estimated shadow prices defined over attributes provided by that consumer. This method ensures that for any given overall budget on all goods and services, the choice engine system provides the optimal combination of attributes, and the maximum quantity of any given attribute given the quantities of the other attributes.

In effect, for a given benefit for the user that reflects the choice of the attributes, the choice engine system chooses an optimal cost-minimising combination of attributes that reflects the underlying shadow prices (ie., marginal cost estimates). Alternatively, for a given cost, the choice engine system chooses the optimal mix of attributes that maximises the consumer's utility, given the preferences of that user and the estimated costs of obtaining these attributes as indicated by the relevant shadow prices. From either perspective, motor vehicles are ranked according to the utility or “consumer” surplus that is accorded to these motor vehicles, that is, measured net of the estimated cost of providing the requisite attributes.

In its simplest form, the personal scores are inputted by the user in the step 303 (FIG. 4) and received in the step 603 (FIG. 5). Hence, knowing the shadow price for each attribute, the preference score for that attribute, the quantities of each attribute in each motor vehicle, and the consumer's desired budget for motor vehicles that might restrict the user's consideration set of feasible motor vehicle should it be necessary, the choice engine computes the optimal quantity of each attribute desired by that consumer. The appropriate price or relative cost of each attribute is given by the estimated shadow price of the attribute (see a step 806 in FIG. 8). This is described in more detail in regard to FIG. 9.

A particular vehicle will obtain a score depending on its shadow prices and the quantities of the attributes embedded in it, as well as the expressed preferences of the given user. However, that vehicle may be highly or lowly ranked. The most highly ranked item(s) will ensure the highest possible surplus for the consumer over and above the cost to that consumer of supplying an appropriate bundle of desired attributes. Such a motor vehicle or motor vehicles will have the highest possible utility score for that user. Motor vehicles which are feasible given any proposed budget if there is one that do not meet this optimality condition will have lower utility scores depending on how much they differ from the ideal. This scoring process enables the user to arrive at the vehicle or vehicle advertisements that are ideal for the user, given his or her expressed preferences.

In situations where the most desirable vehicle is not included in the specific choice item data then a ‘wanted’ advertisement will alert prospective sellers that the most favourable item is missing from the specific choice item data when a scored generic choice item is selected.

The process 400 in FIG. 6 thus ranks candidate items in an order according to (a) those candidate items that provide the user with the desired utility-maximising levels and quantities of each attribute, and (b), the lowest possible objective cost of obtaining the required amounts of each attribute that are ideal for him or her given his or her preferences and the implicit costs of obtaining these attributes as reflected in the relevant shadow prices. This is thus an optimal, or at least a nearly optimal, process that produces the ideal or near-ideal ranking of the motor vehicle in question for a user with the specified preferences and given the estimated shadow prices. Even in circumstances where is either not relevant or not feasible to compute shadow prices at all, the choice engine method is still applicable and optimal from the perspective of the user.

Suppose by way of example that two vehicles have the same ask price and weekly cost of ownership but embody two attributes, safety and performance, in different proportions. Objectively, based on the estimated ‘shadow prices’ and the quantities of the two attributes embedded in the vehicles, the total costs of the two vehicles are the same. However, one vehicle, the sedan, embodies more safety and less performance than the other, a sports car. A user who expresses a higher subjective attribute score for the attribute ‘safety’, and lower score over the attribute ‘performance’, while other preference aspects are the same, will have a higher ranking of the safer but lower performance sedan over the faster but less safe sports car. The utility or surplus for the sedan will be higher for the consumer preferring safer vehicles and, similarly, the consumer with a relative preference for performance over safety will prefer the sports car. Both users will be presented with vehicles that best express their preferences with the safety-preferring user choosing the safer sedan and the performance-preferring user, the sports car.

After the step 402 in FIG. 6, in a step 403 the choice server 107 stores the scored motor vehicles indexed, for example, by the set of subjective relative attribute scores defined in the step 401. In a following step 404 the choice server 107 determines if further sets of weights remain for pre-processing. If this is the case then the process 400 follows a YES arrow from the step 404 back to the step 401. If in contrast no further sets of weights are to be considered, then the process 400 follows a NO arrow from the step 404 to a STOP step 405.

It is noted that the process 400 is performed in relation to the specific comprehensive choice data 724. In practical terms in one arrangement, this means that each advertisement that is provided by the vendor 726 in the specific item data 727 is associated with a set of utility scores by the process 400. Thus, the advertisement for the Toyota Camry® owned by Mr Smith and advertised by the vendor 726 has, by virtue of the process 400, a set of utility scores each associated with a set of subjective relative attribute scores generated by the step 401. When the user 703 provides a set of subjective relative attribute scores either directly or via indicating a desirable or aspirational item in the step 303 of FIG. 4, these subjective relative attribute scores are used to construct the utility score associated with the advertisement for user 703.

These particular utility scores for an advertisement are specific to both the “subjective” information in the form of the user's expressed subjective relative attribute scores, and the “objective” information available for scoring in the form of attribute quantities for that advertisement, the estimated shadow prices of attributes and the user's overall budget. In some cases, the user's proposed budget for the motor vehicle may also be relevant should he or she submit a budget range. In one arrangement described, the score does depend on the “ask” price for that advertisement even when similar vehicles with the same attributes will fall within the same budget range. Typically, for a given make, model, age, credible self-reported condition report, and odometer reading, the lower the asking price, the higher is the rank.

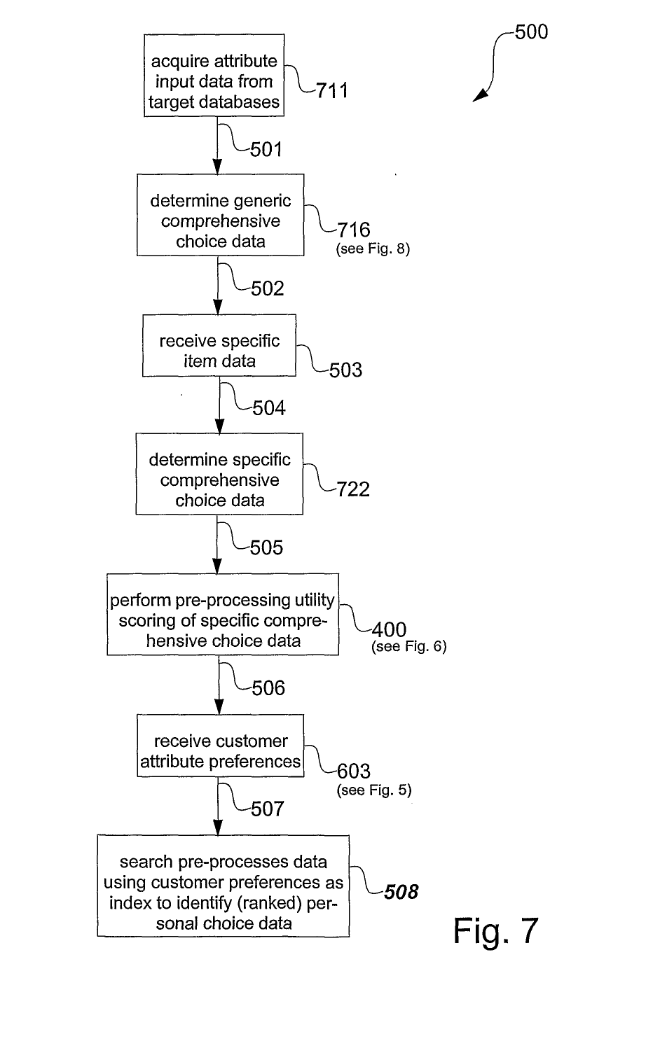

FIG. 7 shows a process flow diagram of how the personal choice data 101 is derived from the target feature data 709. A process 500 commences with a step 711 in which the choice server 107 acquires the attribute input data 714 from the target databases 708. Having regard to motor vehicles, the step 711 can be performed by obtaining market prices of vehicles from Glass®, Redbook® or Bluebook® for new and second-hand vehicles, and by parsing on-line advertisements for second-hand ask prices, odometer readings, vehicle classification and extras. Very large numbers of advertisements are retrieved from Online Classified Websites (OCMs) for vehicles, the information is parsed for content and this is matched to code data in Glass®. In an alternative arrangement, the online internet classified advertisement provider directly supplies the details incorporated in each advertisement without the need for parsing. The Glass® code then provides corresponding technical characteristics (ie features) for each advertised used vehicle. There are also other possible sources of data on technical vehicle specifications from sources such as JATO Dynamics® that supply automotive specification data globally. Typically, enough information is provided in an advertisement to enable a match to be made based upon the make, model and special release of the vehicle against a master database as provided by say Glass Dealer Guide® together with any important optional extras that have been fitted.

In a following step 716 the choice server determines the generic comprehensive choice data 718, as is described in more detail in regard to FIG. 8. Thereafter, in a step 503, the choice server receives specific item data, as depicted by the arrow 727 in FIG. 1, and determines, in a step 722, the specific comprehensive choice data 724. In the following step 400, the choice server performs pre-processing utility scoring of the specific comprehensive choice data 724, as described in relation to FIG. 6.

In the following step 603 the choice server receives the personal subjective relative attribute scores from the user which define the user's attribute preferences (also see the step 603 in FIG. 5). In a following step 508, the choice server searches the pre-processed specific comprehensive choice data 724 to identify and rank the appropriate candidate motor vehicles (in one specification, also the more comprehensive generic choice item data when specific choice item data is not available because advertisements have not been placed for every possible make and model of vehicle and the user may wish to place a ‘wanted’ advertisement) which constitute the personal choice data 101 in FIG. 2.

FIG. 8 shows the step 716 of determining generic comprehensive choice data in FIG. 7 in more detail. The process 716 commences with a step 801 in which the choice server 107 gets the attribute input data items 714 from the choice server database 713 where the data items 714 were stored in the step 711 of FIG. 7.

The process 800 follows two parallel paths after the step 801, one path relating to estimation of cost of ownership of the items in question (ie., step 805), and one relating to identifying, constructing and scoring attributes for the items in question (steps 802-803). Identifying and estimating the cost of ownership is optional and depends on the availability of data on repairs, maintenance and operating costs of vehicles. When such comprehensive data is not available then the price of the item, e.g., the ask price of the vehicle, may be substituted.

In regard to the determination of the cost of ownership, which relates to a particular period of time, in the step 805, the choice server 107 obtains new and second-hand vehicle prices from Glass® Dealer Guide or equivalent data, now stored as attribute input data items 714, and updates the prices to the current period by adjusting by the cost of living (CPI) index. Optional extras from the parsed advertisements can be added to the new price for comparability purposes. The choice server 107 then estimates the Relative Residual Value (RRV) for each make and model within a vehicle segment class, that is the “second-hand” ask price relative to the adjusted new price (“second hand” prices might be obtained from motor vehicle and tax statistics from (say) a motor registry, vehicle auction data, or elsewhere). The depreciation schedule representing the change in the value of each make and model can then be inferred from the RRV. This estimation is performed in terms of the specified vintage (age) of each vehicle and the associated odometer reading (ie., the kilometres travelled by the vehicle).

The step 805 uses regression analysis using Ordinary Least Squares (OLS), or comparable statistical techniques, to estimate depreciation schedules overall, for each vehicle segment, for different makes and make by vehicle segment. It is also possible to use other more sophisticated statistical methods of estimation such as Maximum Likelihood (ML) or the General Method of Moments (GMM). In each case, the most detailed or granular estimate is used. Since second-hand vehicle prices are constantly changing and new values for vehicle-ask prices are being obtained from online classified advertisement, OCA, sites on an ongoing basis, the aforementioned depreciation schedules can be continually updated. The aforementioned method of performing the step 805 is illustrative only, and the step 805 can be done in other ways.

Thereafter, the step 805 estimates the “willingness to spend” on the item in question, e.g., weekly or annual total cost of ownership (i.e., user-charge) in the case of motor vehicles. This estimation is done of the basis of distance travelled, ranging from say 10,000 to 50,000 kms. per annum with operating and maintenance costs for all males and models, extrapolated from data supplied by the NRMA (or other sources) for example, and stored as attribute input data items 714, for a limited number of vehicles. To these costs is added depreciation, obtained as described above and based on the change in the RRV as the vehicle ages, and capital costs reflecting the opportunity costs of funds tied up at each mid-year period. The capital cost is typically set at 10% per annum, however other rates can be used as appropriate

In summary, components of user-charge for vehicles, residual value as a function of vehicle age (vintage) and odometer reading relative to a new vehicle can be estimated using regression analysis and depreciation charge computed. Maintenance, repair, registration, insurance, fuel and running costs for different weekly or annual kilometres can be estimated from data supplied by commercial vendors such as NRMA. Opportunity cost of the capital tied up in the vehicle is estimated by applying an implicit charge such as 10% to the average value of the vehicle during the period.

Turning to the parallel process path involving the steps 802-803, in the step 802 the choice server and the operator thereof identify and/or update the attributes that are considered to be relevant, by identifying attributes that either users care about in the sense that it impacts in a statistically significant manner on the expenditures or outlays per period, or the price that users are prepared to pay for the item in question.

Typically, such attributes that the user cares about and are expensive to provide have positive and significant shadow prices. For example, safer or higher-performance vehicles can be expected to have higher prices if only because it is more expensive for suppliers to make safer and higher-performance vehicles. The choice engine arrangements provide an efficient mechanism for users to input their preferences for attributes and for these to be appropriately ‘traded off’, taking into account the estimated costs of meeting these preferences so that consumers/users can make optimal choices.

The user of the choice engine (703), whom we index (identify) by i, allocates his or her overall budget (ie., for all possible overall expenditures or outlays) $yⁱ for all items between an item of quality q₁ for attribute 1 (which might represent ‘safety’ for a vehicle if the items are (say) vehicles) and quality q₂ for attribute 2 (‘performance’) for which he or she purchases at most one unit of the item (vehicle) and pays $p (item-specific budget, ie., item price) in a competitive market with the remainder of his or her overall budget spent on ‘all other goods’, xⁱ, with a unitary price of $1.

This model can be extended from two to any number, n, of attributes. This simple specification means that the effects of the consumer's overall income on his/her choices concerning the item in question are ignored (absence of income effects).

In the described example relating to motor vehicles, the attributes identified as being of particular importance to the user 703 are (a) safety, (b)luxury, (c) performance, (d) green (environmentally friendly), (e) space, (f) city, (g) towing, (h) economy, and (i) offroad.

In the step 803, the choice server and/or the operator thereof construct each of the aforementioned attributes, dependent upon relevant features that have been acquired in the step 801. Thus, for example, ‘safety’ is an attribute that in the present example, is constructed from fifty nine features, these being observable factors such as presence or absence and number of airbags, vehicle weight, crash test scores, definition of and ‘safe’ vehicle types known to have a very low accident or death rate, presence or absence of four-wheel disk brakes, and so on.

The constructed attributes are refined, using factor analysis, as one example of a statistical technique that can be used. Factor analysis is a statistical tool that uses the correlation structure of the feature data to reduce dimensionality. For example, it is possible to reduce the number of variables making up the “safety” factor from potentially hundreds of features to one or more features. Many features making up the safety factor are highly correlated and thus contain essentially the same information whereas the refined features are “orthogonal” to each other, i.e., uncorrelated. The first two factors that contain a great deal of the explanatory power divide up into an “avoidance” factor and an “amelioration” factor. These two factors, or the first “n” factors can be “weighted” together using the “eigenvectors” of the matrix, or weighted according to their explanatory power to create a single “safety” score.

Since, by assumption, safety is a ‘good” rather than a “bad”, only positive values are acceptable. Thereafter, the safety score is checked for a multitude of motor vehicle makes and models to ensure that safety rankings make sense and agree with rankings by automotive journalists, etc., for a more limited set of makes and models. If there is missing data or some results seem unreasonable or implausible the whole process may need to be done over again until the results are acceptable. Only those attributes having an explanatory power above a predetermined threshold need be preserved, and those falling below the threshold may be discarded without materially affecting the choice engine results.

The choice server 107 then determines, for each candidate motor vehicle of interest, how much of each attribute the candidate motor vehicle has. The amount of a particular attribute that a candidate motor vehicle contains is referred to as an attribute score. Thus, for example, considering the attribute of safety and the component features such as presence or absence and number of airbags, vehicle weight, crash test scores, definition of and ‘safe’ vehicle types, presence or absence of four-wheel disk brakes, each candidate motor vehicle is given an attribute score. Thus, in regard to airbags, a candidate vehicle having airbags would be given an indicator value of “1” while a vehicle not having airbags would be given an indicator value of “0”. This approach is used for each attribute, together with statistical techniques such as factor analysis, to create attribute scores and thus each candidate vehicle is represented by a quantitative vector of attribute scores.

Once the steps 805 and 802-803 are completed, the process 800 is directed to a step 806 in which the choice server 107 performs two distinct but related tasks, namely (a) determining, for each candidate motor vehicle, the shadow prices associated with the attributes, and (b) testing the explanatory power of each combination of attributes. The step (a) determines how much it costs objectively to purchase an additional “unit” of a given attribute, wherein the shadow price reflects the incremental amount of cost corresponding to the attribute in question. Given ‘perfect’ information so that the measure of the quality of each attribute is also ‘perfect’, the shadow price of a particular attribute is independent of the candidate vehicle being considered. Under these circumstances it would cost, for example, $550 to purchase an additional unit of ‘safety’ in any candidate vehicle as the measure of ‘safety’ would be identical across all vehicles. Since, however, the information is not perfect (for example, the disk brakes used in a Ferrari® have greater stopping power and are more reliable than disk brakes in a Toyota Camry®, the shadow prices may vary across candidate vehicles. Typically, for example, particular attributes such as ‘performance’ or ‘safety’ will be more expensive in luxury or high-performance vehicles.

For example, the shadow price of a unit of “safety” may cost more in a vehicle worth $250,000 than in one costing $15,000. This is because a feature, such as for example the presence of disk brakes in a Porsche®, is typically not equivalent to the presence of disk brakes in a relatively cheap vehicle. It is possible to ameliorate such problems by allowing the estimated shadow price to be conditional on the vehicle category, e.g. “small” or “luxury” or by estimating the shadow prices separately for each automotive category or even for each make of vehicle. Substantial differences in these shadow price or marginal cost estimates across vehicle categories relative to the fixed preference scores means that it is important to elicit the appropriate preference scores for each user. A high shadow price for a particular attribute for a relatively high-priced vehicle relative to the preference score means that the user will prefer to purchase the lower priced vehicle as it provides the attribute more cheaply. The user does not value the high-cost attribute sufficiently to consider the higher-priced vehicle.

The step (b) determines the extent to which the attributes identified in the step 802 and constructed in the step 803 are relevant (ie. correct). The measure of correctness is indicated by the incremental explanatory contribution made by each attribute added to the process 800. In other words the weekly (or monthly, or annual) costs of ownership for each make and model of motor vehicle with varying annual kms, or more simply, the various new and secondhand ‘ask’ prices, are ‘explained’ by these created attributes, using regression analysis or variants of related statistical procedures.

If the disclosed choice engine arrangements are applied to relatively low cost items such as MP3 players, IPODs®, or popular digital cameras, or where it is difficult to estimate the components of the per-period cost, the purchase price can be used as a proxy for the “per period” cost of ownership. Here the explanatory power is in terms of the ability of the statistical procedure to explain the purchase price (ie. cost) of the item.

Returning to the vehicle application of the choice engine arrangements, the coefficient of “safety”, which should be statistically significant and positive, is interpreted as the “shadow price” of safety. While this regression describes a linear relationship between user-costs and the quantities of these factors, non-linear relationships are also possible if they provide a better fit to the data. The particular example described assumes linear relationships and that the estimated linear relationships reflect the technological costs of manufacturer supplying these attributes. This process of factor creation and the use of regression analysis to estimate shadow prices ceases once a reasonable set of statistically significant and positive factor prices have been created with a reasonably high overall level of significance (R squared) of say 80% or more.

A following step 807, using the explanatory test described in relation to the step 806 enables those attributes having low or negligible explanatory power to be excluded from the analysis, thus reducing the number of features and attributes that need to be considered. The process 800 can, as depicted by a dashed arrow 810, loop back to the step 802 to enable the attributes to be refined.

A following step 808 stores the aforementioned shadow prices and attribute scores as part of the generic comprehensive choice data 718. The process 800 is then directed, as depicted by an arrow 809, back to the step 801, and the process in this manner is performed on a periodic or continuous manner.

It is noted that the process 716 of FIG. 8 outputs the generic comprehensive choice data 718 for typical hypothetical vehicles, based upon market data drawn from the target feature data 709 in FIG. 1. Such a hypothetical vehicle is, for example, a 1990 Toyota Camry®. The step 722 in FIG. 7 maps this generic comprehensive choice data 718, using the specific item data 727, which can take the form of advertisements for specific motor vehicles, to the specific comprehensive choice data 724 which relates to “real” or “actual” vehicles. Such a real vehicle is, for example, the 1990 Toyota Camry® owned by Mr. Smith.

FIG. 9 is a flow diagram showing a utility scoring process 900 that is used, for example, in FIG. 7. The process 900 commences with a step 901 in which the choice server 107 defines the user's utility objective relationship (ie. utility function) specified over the attributes (determined in the step 802 in FIG. 8) and the personal preference weights (provided by the user in the step 303 in FIG. 4) contained in one unit of the item in question (although in principle there can be more than one unit), and the (notional) expenditure by the user on all other goods and services other than the one item of the good or service in question. It is not required to import or provide such information on all other expenditure. A simple two-attribute example of such a utility objective relationship is provided in equation (1) below.

In a following step 903, the choice server 107 determines an overall budget constraint and how this (once again notional) constraint equals the user's outlay on the item in question given by the price of the item as some function of the quantities of the attributes (in this example a motor vehicle) plus all the other items of expenditure on all other goods and services. A numerical example of this step is given by equation (2) below, once again for the simple case of an item with two attributes.

Thereafter, in a step 905 the choice server 107 determines the shadow prices (ie. marginal costs) (determined in the step 806 in FIG. 8) of the attributes associated with each item, eg the make and model of a vehicle in this example. A numerical example of this step is given in equations (3) to (8) below.

In step 907 the choice engine maximises the utility objective inclusive of the respective shadow prices of attributes. A numerical example of this step is given by equations (7) to (25) below.

Finally, in a step 909, the choice server 107 scores the candidate items given the specified quantities of the attributes, the preference weights, and the corresponding shadow prices for each candidate item. A numerical example of how the scoring is performed is given in equations (24) and (26).

### A Numerical Example of Determining Utility Scores

Determination of utility scores, referred to in the steps 604 (FIG. 5), 402 (FIG. 6), and the process 400 (FIGS. 6 and 7) can, in one example, be performed as described below.

We take as our example the simple quadratic function specification, initially with respect to only two attributes. Later this is extended to an arbitrary number (n) attributes. The consumer possesses the simple quadratic utility function (or some approximation to it) expressed as follows:

$$u ( {q}_{1} , {q}_{2} ) = {a}_{0}^{i} + {a}_{11}^{i} {q}_{1} - \frac{{a}_{12}^{i}}{2} {q}_{1}^{2} + {a}_{21}^{i} {q}_{2} - \frac{{a}_{22}^{i}}{2} {q}_{2}^{2} + {x}^{i} , \qquad ( 1 )$$

where a₀ is an additive constant term, a₁₁ⁱ denotes the linear preference score or ‘utility weight’ specific to consumer i that he or she places on attribute 1 multiplied by the quantity of attribute 1, q₁ (effectively, the quality of this attribute), and

$$- \frac{{a}_{12}^{i}}{2}$$

the negative coefficient of the quadratic (squared) term q₁². Similarly, the coefficient a₂₁ⁱ, applicable to the quantity of the second attribute, q₂, and

$$- \frac{{a}_{22}^{i}}{2} ,$$

the negative weight on the square of q₂, q₂², represent the coefficients on the second attribute, here ‘performance’. Hence users who place a high value on attribute 1 (‘safety’) relative to attribute 2 (‘performance’) will have a preference value a₁₁ⁱ, a₁₂ⁱ and if satiation in safety occurs with higher attribute levels for safety relative to performance then

$$\frac{{a}_{12}^{i}}{2} < \frac{{a}_{22}^{i}}{2} .$$

What this condition means is that, while the marginal valuation to the user of any attribute will be declining as more of the attribute is included in any given item such as a motor vehicle, the rate of decline for safety relative to performance is lower. As the vehicle increases in quality with both greater safety and higher performance, the vehicle chosen by this user will tend to improve in safety relative to performance. Several mechanisms for establishing these values are described below.

In equation (1) above according to one arrangement, the representation of ‘all other goods’, xⁱ, occurs in a simple linear fashion. Alternately, at the expense of making finding the optimal solution more complex, a functional form such as a quadratic expression that is positive and linear in ‘all other goods’, xⁱ, and negative in the square of ‘all other goods’, (xⁱ)², and similar to the terms for attributes can be introduced. However, one of the advantages of the simple methodology proposed is that neither the overall budget constraint, yⁱ, nor the expenditure on ‘all other goods’, xⁱ, needs to be known or supplied by the user (703) of the choice engine.

There are several methods by which these linear attribute coefficients for each of the attributes of q₁ and q₂, a₁₁ⁱ, and a₂₁ⁱ respectively, can be obtained in an approximate form. In a first arrangement, this can be done by a form of self-reporting e.g., clicking, using the mouse 212, on particular boxes on the screen 202 that rank different attributes of the item which are then used to construct estimates of the above coefficients. This sort of arrangement and a variant on it are discussed below in more detail. In an alternate arrangement, the user can click on a particular item (e.g., a desirable vehicle that is aspirational for that user) they like as the first step towards inputting their preferences. The user is then given the opportunity to modify these preferences. This method is described in more detail below. Equation (1) is not used directly in the choice engine calculations. Rather, the methodology for establishing the choice engine proceeds as follows:

The user maximises the personalised utility expression (1) subject to his or her overall budget constraint, which is expressed as follows:

yⁱp(q₁ⁱ, q₂ⁱ)+xⁱ, (2)

where yⁱ represents his or her overall income or budget and p(q₁ⁱ, q₂ⁱ) is the price for the item such as a motor vehicle containing q₁ⁱ units of the attribute 1 and q₂ⁱ units of attribute 2. Thus in this simple example only one item is to be chosen.

Using equation (2) to solve for the quantity of ‘all other goods’, xⁱ, and substituting into equation (1) yields the following expression for utility (for simplicity, superscripts are omitted from the attribute quantities):

$$u ( {q}_{1} , {q}_{2} ) = {y}^{i} + {a}_{0} + {a}_{11}^{i} {q}_{1} - \frac{{a}_{12}^{i}}{2} {q}_{1}^{2} + {a}_{21}^{i} {q}_{2} - \frac{{a}_{22}^{i}}{2} {q}_{2}^{2} - p ( {q}_{1} , {q}_{2} ) , \qquad ( 3 )$$

in which the observed actual or asking price is deducted from the overall income term, yⁱ, and the preference terms involving the attributes. The term, yⁱ, can also be dropped from equation (3), as can the constant term, a₀, as they play no further role. They do not vary with the attributes or price of the item such as a vehicle.

In addition to the utility objective function described by equations (1) and (3) above representing users (703) of the choice engine, producers of the item (motor vehicle in the described examples) in question need to make choices over what characteristics of the item are actually available in the market place. Producers of the item are assumed to decide what attributes to include in the item when they maximise the profitability of their manufacturing, importing or distribution activities. Their opportunities are described by the simple linear profit function, π(q₁,q₂), that depends on the attributes, q₁ and q₂ incorporated into the item. This profit function, in addition to terms which are linear in q₁ and q₂, that is, b₁ and b₂, can also contain multiplicative interaction terms between the attributes as shown in the following example of a simple two-attribute relationship:

π(q₁,q₂)=p(q₁,q₂)−(b₀+b₁q₁+b₂q₂+b₁₂q₁q₂), (4)

where p (q₁, g₂) is the price the producer/supplier receives for the item containing q₁ units of attribute 1 and q₂ units of attribute 2 and also the ask price for the item in question, b₀ is a constant term, b₁ the linear function coefficient or shadow price for attribute 1 and b₂ the coefficient or shadow price of attribute 2, and b₁₂ the multiplicative interaction term, describes how the cost of producing/supplying one attribute varies with the provision of another attribute of the item in question. Multiplicative interaction terms are optional.

Although not shown in equation (4), the right hand side of the equation can include a whole host of ‘control’ variables such as the make and model of the vehicle, its age or vintage, if it is the current model, the life of the model, a whole variety of variables describing the condition of the vehicle such as engine, transmission, suspension, steering, brakes, tyres, bodywork, upholstery, registration period remaining, nature of the sale price, eg. dealer, private, wholesale, auction, etc.

The fact that the profit function expressed by equation (4) is either not indexed by the producer/supplier (that is, b₀, b₁, b₂ and b₁₂ are assumed to be the same, or at least fairly similar across suppliers such as Ford, General Motors, Toyota, Mercedes, etc. or these variations are taken into account) indicates the simplifying assumption being made here that the variation in technology across producers/suppliers is not nearly as great as the variation in preferences across users of the choice engine. If this is not the case then there are estimation techniques that can be used to identify the cost or technology parameters and separate them from the preference parameters.

Producers/suppliers maximise profits π(q₁,q₂) in equation (4) by choosing the quantities (in effect, their quality) of the attributes (in this simple case, just q₁ and q₂) appropriately, with the following two first-order conditions giving the incremental impact on the price at which the item can be sold less the incremental cost of adding to these attributes, where the symbols,

$$\frac{\partial π}{\partial {q}_{1}} ,$$

indicate the change in the numerator with respect to a small change in the denominator:

$$\begin{matrix}\frac{\partial π ( {q}_{1} , {q}_{2} )}{\partial {q}_{1}} = \frac{\partial p ( {q}_{1} , {q}_{2} )}{\partial {q}_{1}} - ( {b}_{1} + {b}_{12} {q}_{2} ) = 0 , \\ and & ( 5 ) \\ \frac{\partial π ( {q}_{1} , {q}_{2} )}{\partial {q}_{2}} = \frac{\partial p ( {q}_{1} , {q}_{2} )}{\partial {q}_{2}} - ( {b}_{2} + {b}_{12} {q}_{1} ) = 0. & ( 6 )\end{matrix}$$

Moreover, a competitive market for the supply of the item in question is assumed (it is possible to relax this assumption and to allow suppliers to possess market power). This ensures that the price function p(q₁, g₂) is identical to the cost/technology function described by the relationship b₀+b₁q₁+b₂q₂+b₁₂q₁q₂ so that, on substituting the expression for the pricing equation into equation (3), the user objective (utility) function becomes:

$$u ( {q}_{1} , {q}_{2} ) = {y}^{i} + {a}_{0} + {a}_{11}^{i} {q}_{1} - \frac{{a}_{12}^{i}}{2} {q}_{1}^{2} + {a}_{21}^{i} {q}_{2} - \frac{{a}_{22}^{i}}{2} {q}_{2}^{2} - ( \begin{matrix}{b}_{0} + {b}_{1} {q}_{1} + \\ {b}_{2} {q}_{2} + {b}_{12} {q}_{1} {q}_{2}\end{matrix} ) . \qquad ( 7 )$$

Note that we can drop the overall income or budget term y¹ in equation (7) as typically we do not have (or for that matter, need) information on the consumer's overall budget or income for users of on-line classified advertising sites. However, it can easily be retained in situations in which this data is available, for example, self-reported, survey or census data. Moreover, we can also drop the two constant terms, a₀ and b₀, and coefficients of additional ‘control’ terms, at some stage if we so wish as they do not vary with the levels of attributes contain in the item.

For mathematical convenience, the attributes q₁ to qₙ in the regression equation (equation (8)) below are defined to represent “positive qualities” rather than “negative qualities” with positive signs in which case only positive qualities appear on the RHS of the equation (1). The associated shadow prices b₁ to bₙ, defined in the step 806 in FIG. 8, are also defined to be positive. Thus, for example, if the jth attribute score, qⱼ, is a measure of unreliability, then the variable should be transformed such that “absence of unreliability”, i.e., (say) reliability, becomes the measure.

One way to transform a variable is to take the inverse. For example, if initially qⱼ is a continuous variable (rather than a dummy variable), vehicle vintage (age), with regression coefficient, bⱼ<0, then redefine ‘vintage’ as say, ‘inverse vintage’ or ‘newness’,

$$\frac{1}{{q}_{j}^{i}} ,$$

with a new vehicle specified to be of vintage “1”, less than 1 year, “2”, 1-2, “3”, and so on.

The aforementioned steps use a scoring system based on consumer utility maximisation. In one example, this is determined using regression based on a linear form with n (being 9 in the present example) attributes q₁ to qₙ being, as determined in the step 803 of FIG. 8, (a) ‘safety’, (b) ‘luxury’, (c) ‘performance’, (d) ‘green’ (environmentally friendly), (e) ‘space’, (f) ‘city’, (g) ‘towing’, (h) ‘economy’, and (i) ‘offroad’.

The price function p(q₁, g₂)=b₀+b₁q₁+b₂q₂+b₁₂q₁q₂ appearing in equation (7) and expressed in linear form has to be estimated using conventional regression techniques from many observations on the observed prices of the item in question and attributes q₁, q₂, etc. Note that it is often advisable to estimate separate relationships for (say) each class of vehicles if the item in question is vehicles. Taking the prices or asking prices of the items in question as the dependent variable (alternatively, the weekly cost of ownership) yields an Ordinary Least Squares (OLS) (or a similar statistical technique) regression equation of the following form:

p(q₁,g₂)=b₀+b₁q₁+b₂q₂+b₁₂q₁q₂+ε, (8)

where:
ε is the error term (difference between the actual value, namely p(q₁,g₂), and predicted value, namely b₀+b₁q₁+b₂q₂+b₁₂q₁q₂, for a particular observation on (say) price) which is assumed to be normally distributed with an expected value of zero;
p(q₁,g₂)>0 is the outlay in dollars on the item in question, for example, the weekly cost of vehicle ownership for each particular vehicle with different attribute specifications or the prices of new and secondhand vehicles with different attributes or the actual trading (possibly asking) prices for different makes and models of motor vehicle both new and second-hand;
q₁ to qₙ are the quantities of the attributes defined in the step 803 in FIG. 8 for each item with n set equal to two in equation (8);
n is the number of attributes but in this example is set to n=2;
qᵢ is the quantity of the ith factor (ie., attribute);
b₁ to bₙ are the estimated coefficients from the regression which are interpreted as shadow prices, or marginal costs of supplying the attribute, with b₀, the “constant” term or unexplained portion of the outlay per unit time period and the interaction terms, bⱼₖ, between the jth and kth attribute, which can be either positive or negative so long as the optimal solutions for the quantities of the attributes desired, equations (12) and (13) below, are non-negative, q*ⱼⁱ≧0, reflects the way that the marginal costs of supply of one attribute are affected by another.

Apart from Ordinary Least Squares (OLS) other suitable estimation techniques for the regression equation include Maximum Likelihood (ML) and Make/Model Fixed Effects (FE). In a FE regression indicator variables (intercepts) are included for all but one of the various makes and models of motor vehicle.

It is also advisable to transform a number of variables prior to estimating the regression. For example, the prices or user-costs of each vehicle should be scaled on the zero to one range by deflating by the highest priced (or user-cost) vehicle and each attribute should also be scaled on the zero to one range for the entire database.

If a vehicle has done k kms (according to the odometer reading) and is of “newness”, j, (say inverse of vintage) then the estimated price function coefficients may be, bⱼ>0, bₖ>0 and bⱼₖ of either sign. The strength or weakness of the model and specification of factors depends primarily on the ability of the constructed factors to explain the regression equation (8) between the prices or ‘user’ costs of all the items and the quantities of the attributes embodied in each item.

If, for example, attributes are poorly designed or constructed then they will not be able to “explain” much of the variation in item outlays, p(q₁,g₂), or costs, from regression equation (8) using the attributes, q₁ and q₂. Not only may the shadow prices, b₁ to b₂ be statistically insignificant but the overall fit of the equation may be poor with low explanatory power, (i.e., low R²). Thus any new factor, such as a “wow” factor for vehicles should be statistically significant and add to the overall explanatory power. Since the regression equation estimation of shadow prices may not always perform well, as is indicated in equation (26) below, it is particularly important to include the residual value (difference between the ask price of the item and its predicted value) in the scoring equation.

Presently implemented examples of the disclosed choice engine approach for ten standard vehicle segments account for about 80% of the fit of the equation (1) with market-based vehicle prices.

The utility function of the user of the classified advertising site (or similar), incorporating the coefficients of the price regression and hence ‘shadow price’ coefficients, as represented by equation (7), can now be maximised by choosing the quantities of the attributes q₁ and q₂ appropriately to yield the following first-order conditions of the maximisation problem:

$$\begin{matrix}\frac{\partial u ( {q}_{1} , {q}_{2} )}{\partial {q}_{1}} = u ( {q}_{1} , {q}_{2} ) = {a}_{11}^{i} - {a}_{12}^{i} {q}_{1} - ( {b}_{1} + {b}_{12} {q}_{2} ) = 0 , \\ and & ( 9 ) \\ \frac{\partial u ( {q}_{1} , {q}_{2} )}{\partial {q}_{2}} = u ( {q}_{1} , {q}_{2} ) = {a}_{21}^{i} - {a}_{22}^{i} {q}_{2} - ( {b}_{2} + {b}_{12} {q}_{1} ) = 0 , & ( 10 )\end{matrix}$$

where the user's linear preference coefficients are a₁₁ⁱ and a₁₂ᵢ as defined in relation to equation (1) above, a₁₂ⁱ and a₂₂ⁱ are the user preference coefficients of the quadratic attribute quantities, q₁² and q₂², also defined in equation (1), and the remaining coefficients are the estimated ‘shadow’ prices or marginal costs, b₁, b₂ and b₁₂, as defined and estimated by equation (8).

Note that the sufficient condition for a maximum requires that marginal utility is falling more rapidly than marginal cost at the optimum point with respect to the incremental impact of the two attribute variables. The condition with respect to the first and second attribute variables are as follows:

$$\frac{{\partial }^{2} u ( {q}_{1} , {q}_{2} )}{\partial {q}_{1}^{2}} = - {a}_{12}^{i} {q}_{1} < 0 ; \frac{{\partial }^{2} u ( {q}_{1} , {q}_{2} )}{\partial {q}_{2}^{2}} = - {a}_{21}^{i} {q}_{2} < 0. \qquad ( 11 )$$

On solving the first-order conditions with respect to q₁ and q₂, equations (9) and (10), the optimal solution for q₁=q*₁ is expressed as follows:

$${q}_{1}^{* i} = \frac{{a}_{22}^{i} ( {a}_{11}^{i} - {b}_{1} ) - {b}_{12} ( {a}_{21}^{i} - {b}_{2} )}{{a}_{12}^{i} {a}_{22}^{i} - {b}_{12}^{2}} \geq 0 , \qquad ( 12 )$$

and for q₂=q*₂ is as follows:

$${q}_{2}^{* i} = \frac{{a}_{12}^{i} ( {a}_{21}^{i} - {b}_{2} ) - {b}_{12} ( {a}_{11}^{i} - {b}_{1} )}{{a}_{12}^{i} {a}_{22}^{i} - {b}_{12}^{2}} \geq 0. \qquad ( 13 )$$

These expressions (12) and (13) state in the absence of technology (marginal cost) interaction effects that are set to zero, b₁₂≡0, that for the ith consumer

$${q}_{1}^{* i} = \frac{{a}_{11}^{i} - {b}_{1}}{{a}_{12}^{i}} and {q}_{2}^{* i} = \frac{{a}_{21}^{i} - {b}_{2}}{{a}_{22}^{i}} ,$$

so that for the jth attribute

$${q}_{j}^{* i} = \frac{{a}_{j 1}^{i} - {b}_{j}}{{a}_{j 2}^{i}} .$$

Hence for positive optimal attribute scores or values for the jth attribute to obtain, q*ⱼ>0, the marginal preference weighting for the ith consumer exceeds the estimated marginal cost, aⱼ₁ⁱ>bⱼ. Moreover, the smaller is the absolute value of the quadratic preference term for the ith consumer for each attribute, a^{j2}ⁱ, the more of the jth attribute will be chosen by the ith user or consumer, the larger is q*ⱼⁱ.

Replacing price p(q₁) in equation (3) with just a single attribute by the equivalent linear regression equation (8), also with just a single attribute, yields the following equations:

$$\begin{matrix}{u}^{i} ( {q}_{1} ) = {a}_{0}^{i} + {a}_{11}^{i} {q}_{1} - \frac{{a}_{12}^{i}}{2} {q}_{1}^{2} + {y}^{i} - ( {b}_{0} + {b}_{1} {q}_{1} + ɛ ) , \\ = {y}^{i} + {a}_{0}^{i} - {b}_{0} - ɛ + ( {a}_{11}^{i} - {b}_{1} ) {q}_{1} - \frac{{a}_{12}^{i}}{2} {q}_{1}^{2} ,\end{matrix} \qquad ( 14 )$$

where ε is the identically distributed error term with an expected value of zero.

The more general expression for n attributes is expressed as follows:

$${u}^{i} = {y}^{i} + {a}_{0}^{i} - {b}_{0} - ɛ + ( {a}_{11}^{i} - {b}_{1} ) {q}_{1} + … + ( {a}_{n 1}^{i} - {b}_{n} ) {q}_{n} - \frac{{a}_{12}^{i}}{2} {q}_{1}^{2} - \frac{{a}_{22}^{i}}{2} {q}_{2}^{2} - … - \frac{{a}_{n 2}^{i}}{2} {q}_{n}^{2} . \qquad ( 15 )$$

Optimising with respect to q₁ (or a vector of quality attributes) yields an interior solution for the optimal quality q*₁ⁱ (or quality vector, q*₁ⁱ,q*₂ⁱ, . . . ,q*ₙⁱ, across the n attributes) for the ith consumer such that utility is maximised:

$${q}_{1}^{* i} = \frac{{a}_{11}^{i} - {b}_{1}}{{a}_{12}^{i}} , \\ {q}_{2}^{* i} = \frac{{a}_{21}^{i} - {b}_{2}^{i}}{{a}_{22}^{i}} , \\ {q}_{n}^{* i} = \frac{{a}_{n 1}^{i} - {b}_{n}}{{a}_{n 2}^{i}} . \qquad ( 16 )$$

These n solutions (one for each of the n attributes) given by equation (16) are only simpler than those provided in the two-attribute case above, equations (12) and (13) above, because interaction terms are not included in the technology/cost specification.

The quadratic utility function ensures that there is an optimal interior solution for each of the quality attributes. Quality is increasing in the linear user-weight coefficients, a₁₁ⁱ,a₂₁ⁱ, . . . ,aₙ₁ⁱ, diminishing in the ‘shadow’ price (marginal cost) regression coefficients, b₁ⁱ,b₂ⁱ, . . . ,bₙⁱ, for that quality item representing the marginal cost(s) of providing that (those) quality attribute(s) for that item, and is declining in the quadratic utility coefficients, a₁₂ⁱ,a₂₂ⁱ, . . . ,aₙ₂ᵢ, with the negative signs in the utility function representing the diminution in marginal utility with increases in quality. Thus for each attribute the consumer/user can rapidly become satiated, and prefer at least a little of some other attribute.

Plugging the solution (or solution vector) given by (16) into the simple single attribute expression for utility, equation(14), yields the following:

$$\begin{matrix}{u}^{* i} = {y}^{i} + {a}_{0}^{i} + {b}_{0} - {ɛ}^{*} + \frac{{( {a}_{11}^{i} - {b}_{1} )}^{2} - \frac{1}{2} {( {a}_{11}^{i} - {b}_{1} )}^{2}}{{a}_{12}^{i}} , \\ = {y}^{i} + {a}_{0}^{i} - {b}_{0} + \frac{1}{2} \frac{{( {a}_{11}^{i} - {b}_{1} )}^{2}}{{a}_{12}^{i}} - {ɛ}^{*} ,\end{matrix} \qquad ( 17 )$$

for the single attribute case, where the superscript term, *, indicates the optimum value. The multiple attribute solution for optimised utility is expressed as follows:

$${u}^{* i} = {y}^{i} + {a}_{0}^{i} - {b}_{0} + \frac{1}{2} \frac{{( {a}_{11}^{i} - {b}_{1} )}^{2}}{{a}_{12}^{i}} + \frac{1}{2} \frac{{( {a}_{21}^{i} - {b}_{2} )}^{2}}{{a}_{22}^{i}} + … + \frac{1}{2} \frac{{( {a}_{n 1}^{i} - {b}_{n} )}^{2}}{{a}_{n 2}^{i}} - {ɛ}^{*} . \qquad ( 18 )$$

Thus if the item is optimal for the ith user, as indicated by the superscript *, then the marginal costs and benefits with respect to quality (or vector of qualities) are equal and the utility score is increasing in overall income, yⁱ, which will be allocated to all budgetary items and in the squared difference between the marginal benefit to the ith consumer aⱼ₁ⁱ and marginal cost b₁, deflated by the rate aⱼ₂ⁱ at which marginal utility is declining for the jth attribute.

The residual error of estimate from the regression equation (8) for the optimal item ε*, should be subtracted from the utility score. This residual error of estimate is equal to the difference between the actual or ‘ask’ price of the item as it may, for example, be displayed on a classified advertisement web site and its predicted price given by the estimated equation (equation (8) in the simple case of two attributes). This ensures that the full ask price or actual cost of the item in question is deducted in obtaining the appropriate score for the optimal item.

For all items (e.g., vehicles represented by classified advertising) that are not optimal, the utility score will be lower: uⁱ≦u*ⁱ, and thus the vehicle ranking will also be lower in the sort order.

For every consumer (user of the choice engine tool 703) there are two unknowns, aⱼ₁ⁱ which is the linear coefficient and aⱼ₂ⁱ which is the quadratic coefficient, for the jth attribute and with similar terms for every quality attribute that the ith user cares about. Hence obtaining these in a simple, quick and effective manner would seem a formidable task.

Using a method based on self-reporting of attribute preferences, there are several ways in which the necessary preference information can be obtained. Since utility cannot be negative for a particular attribute the desired attribute value is set to zero whenever the ‘shadow’ price marginal cost estimate, bⱼ, for the jth attribute for a particular item such as a make and model of vehicle exceeds the marginal valuation for that attribute placed on it by the ith user, at aⱼ₁ⁱ. Thus qⱼⁱ is zero whenever bⱼ≧aⱼ₁ⁱ. Thus one can proceed by requesting values for the aⱼ₁ⁱ coefficients from users of the choice engine directly as in relation to equation (1) above as one approach.

Alternatively, and normally inappropriately, one can request from the user estimates of the jth subjective preference weight specified in the form of a percentage or proportional margin based on the marginal cost estimate, bⱼ as follows:

aⱼ₁ⁱ=(1+αⱼ¹)bⱼ, (19)

where the alpha coefficient αⱼⁱ is the proportion by which the linear preference weight aⱼ₁ⁱ differs from the shadow price estimate bⱼ. However, for attributes of expensive items (for example, the ‘performance’ attribute of a Ferrari® with high marginal costs the estimate of bⱼ may be high putting it out of reach for the ith user. In such a case the proportion, αⱼⁱ, would optimally be zero in the case of a Ferrari®. Thus the problem with the simple proportional approach given by equation (19) is that there is no reason to think that the aⱼ₁ⁱ preference weight for the jth attribute will be higher just because the shadow price, bⱼ, is high for an expensive vehicle or expensive class of vehicle such as luxury sports cars.

If in the absence of other information about how the user responds to increasing exposure to particular attributes, the quadratic coefficient terms, aⱼ₂, are all set to identically equal 1 (ie can be set to unity), then knowledge of the vector of aⱼ₁ⁱ preferences and estimated marginal cost (shadow price) estimates, bⱼ, is sufficient to specify the optimal quantity of the jth attribute for the ith consumer as follows:

q*ⱼⁱ=aⱼ₁ⁱ−bⱼ for all j, jε(1,n). (20)

The user may also need to filter out items that exceed his or her budget limit for that type of item such as a vehicle or report a budget range for that type of item and have the choice engine report a filtered list of items meeting the pre-imposed limitation.

While pre-scored advertisements can contain a variety of possible budget ranges, ultimately in one form or another, it is the user who indicates which of a range of possible weekly, monthly or annual budgets he or she is interested in. This can be provided by the user in the step 303 in FIG. 4. Alternately, the user can provide a price range for his vehicle of choice in the step 303 in FIG. 4. Typically, the price/budget range that the user prefers is specified at the same time as he indicates his personal preference attribute weights in the step 303 in FIG. 4. Since the choice engine arrangements typically rank all vehicles from highest to lowest reflecting the user's preferences and this ordering will typically be from more to less expensive vehicles, the user is also free to choose the appropriate vehicle at this point by filtering out vehicles with prices exceeding his consideration set. Hence, it may not be necessary to pre-specify a maximum outlay on a vehicle.

As described in relation to the step 303 in FIG. 4, the user needs to specify his own set of preference weights, aⱼ₁ⁱ, for jε(1,n). The information necessary to compute the optimal attribute levels and preferences for each consumer can be obtained by having selectable (say) low, medium and high preference weights (aⱼ₁ⁱ) value click boxes displayed on the screen 202 for each attribute on a webpage. From these responses values can be substituted for the low medium and high scores where the lowest value exceeds the lowest shadow price estimate for that attribute and where the highest value exceeds the highest or most expensive shadow price estimate for that attribute.

In this display, and associated with each score, examples of (say) vehicles with attribute scores in the low medium and high range, aⱼ^{L,M,or H}, can be presented. The most relevant attributes can be pre-populated with typical values giving rise to the most popular vehicle choices with these values changeable at the will of the user. If the specific comprehensive choice data 724 is pre-processed (according to the process of FIG. 6), this is equivalent to choosing a particular set of weights aⱼ₁ⁱ already included in the specific comprehensive choice data 724. Moreover, other than knowing that their own weights are, for example, low medium or high or in a low or high decile range, the user need not get to see the actual scoring system used in the choice engine arrangements.

Thus, in one arrangement, predetermined weights aⱼ₁ⁱ can be presented to the user on the display 202 by the choice server 107 (see FIG. 3) and the user 703 is required to choose one of the displayed sets of pre-defined weights. In another (pre-processed) arrangement, the user can input their desired weights, aⱼ₁ⁱ, however the system 200 will select the closest set of predefined weights in the predetermined specific comprehensive choice data 724.

As possibly a more effective method, we proceed as follows: We ask the user to tick an item (using the mouse 212 to select appropriate tick boxes in a presentation on the display 202) such as a make and model and vintage from a list that is his or her initial favourite and potentially his or her preferred purchase but also possibly outside his or her direct consideration set for budgetary reasons.

On appropriate websites every advertisement can potentially be coded in this way.

Suppose the ith user chooses the item indexed by i. Since the set of attribute scores, q₁,q₂, . . . ,qₙ, for every item including the ith item have been calculated in step 803 in FIG. 8 and the estimated regression (marginal cost) coefficients, b₁,b₂, . . . ,bₙ, for each of the n computed quality attributes for that item have been computed using a generalised version of equation (8) in step 806 of FIG. 8, the choice engine system solves the set of solution vectors, equation (20) (or more generally, equation (16)), to obtain the solution for the main (positive) coefficient for that attribute for that consumer/user with vehicle i as his aspirational choice, expressed as follows:

aⱼ₁ⁱ=q*ⱼⁱ+bⱼ,jε(1,n), (21)

on substituting for aⱼ₁ⁱ using equation (20). In words, the subjective preference score equals the optimal attribute quantity relevant for the vehicle chosen by the ith user plus its estimated shadow price.

Using this method the choice engine system obtains as many user weights, a₁₁ⁱ,a₂₁ⁱ, . . . ,aₙ₁ⁱ as there are attributes for that item. Since the values for the n weights a₁₂ⁱ to aₙ₂ⁱ for the quadratic attribute terms cannot be solved for, in one example we set each of these set of n values to an arbitrary number such as 1, as previously done in equations (20) and (21) above. Alternatively, these values can be elicited from the user at the same time as the linear weights, a₁₁ⁱ,a₂₁ⁱ, . . . ,a_{b1}ⁱ. Utilising equations (18) and (21), the utility score for that consumer (denoted i) making an optimal choice with just one attribute qⱼ now becomes the following:

$${u}^{* i} = {y}^{i} + {a}_{0}^{i} - {b}_{0} + \frac{1}{2} {( {q}_{j}^{* i} )}^{2} - {ɛ}^{*} , \qquad ( 22 )$$

and for two or more attributes:

$${u}^{* i} = {y}^{i} + {a}_{0}^{i} - {b}_{0} + \frac{1}{2} [ {( {q}_{j}^{* i} )}^{2} + {( {q}_{2}^{* i} )}^{2} + … + {( {q}_{n}^{* i} )}^{2} ] - {ɛ}^{*} . \qquad ( 23 )$$

Since the utility score depends of the sum of the squared attribute values, these should all be normalised on (say) the zero to one range (qⱼε(0,1)) prior to computing the regression coefficients, b₁, b₂, . . . ,bₙ, utilising equation (8). Likewise, the vehicle prices (alternatively, user-costs) should also be normalised on the zero to one range prior to carrying out the regression specified in equation (8). The normalisations ensure that both the optimal attribute score and the difference between the preference weight and shadow price all lie in the zero to one range: 0≦q*ⱼⁱ=aⱼ₁ⁱ−bⱼ≦1.

It is noteworthy that the utility score varies across classified advertisements, even for the same make, model, odometer reading, and year, as it depends on the negative of the prediction error for that advertisement. If there are two vehicles of identical specifications and ages, the one with the lower asking price will be ranked higher. The constant terms yⁱ+a₀ⁱ are essentially arbitrary constants that can be set sufficiently positive to make the utility score positive no matter how negative may be the prediction error, −ε*ⱼ from the regression equation.

Plugging in the optimum values for aⱼ₁^{i=b}+q*ⱼⁱ and aⱼ₂ⁱ=1 for all vehicles in the utility score equation derived from equation (15) and found by setting the terms, a_{J2}ⁱ=1:

$${u}^{i} = {y}^{i} + {a}_{0}^{i} - {b}_{0} - ɛ + ( {a}_{11}^{i} - {b}_{1} - \frac{1}{2} {q}_{1} ) {q}_{1} + … + ( {a}_{n 1}^{i} - {b}_{n} - \frac{1}{2} {q}_{n} ) {q}_{n} , \qquad ( 24 )$$

provides a ranking for the i^{th} consumer with his aspirational choice (the i^{th}) either at the top, or close to the top. On evaluating equation (24) for the user who initially thinks that the ith item may be ideal, every advertisement can be scored relative to the optimal or maximal score, uⁱ*, given by the utility function scores as follows:

$$\begin{matrix}{u}^{* i} = {y}^{i} + {a}_{0}^{i} - {b}_{0} - ɛ + ( {b}_{1} - {b}_{1} + {q}_{1}^{* j} ) {q}_{1}^{* j} + … + \\ ( {b}_{n} - {b}_{n} + {q}_{n}^{* j} ) {q}_{n}^{* j} - \frac{1}{2} ( {q}_{1}^{* 2} + … + {q}_{n}^{* 2} ) \\ = {y}^{i} + {a}_{0}^{i} - {b}_{0} - ɛ + \frac{1}{2} {q}_{1}^{* 2} + \frac{1}{2} {q}_{2}^{* 2} + … + \frac{1}{2} {q}_{n}^{* 2} \\ = {y}^{i} + {a}_{0}^{i} - {b}_{0} - ɛ + \frac{1}{2} ( {q}_{1}^{* 2} + {q}_{2}^{* 2} + … + {q}_{n}^{* 2} )\end{matrix} \qquad ( 25 )$$

where the term, ε*, denotes the residual value from the regression equation (8) for the specific candidate item (e.g. advertised vehicle) with the requisite optimal set of attributes, q*₁, . . . ,q*ₙ, that has the lowest ask price relative to the predicted price for that item (eg. make and model of vehicle). Thus the optimal residual regression value ε* could well be negative, indicating that the ask price is low compared with comparable items. This procedure can ensure that the lowest asking price item with comparable attribute scores to other items has the highest score and thus highest rank. If there is no specific item then a generic item can be substituted.

Equation (25) reduces to an index consisting of half the sum of the squared attribute scores for that item optimal of the ith investor. It only applies to the optimal choice. However, once the coefficients a₁₁ⁱ,a₂₁ⁱ, . . . ,aₙ₁ⁱ have been extracted for the optimal choice it is now possible to (say) compute scores for every other similar item in the database 713 using equation (24) for this user and rank them relative to the optimal item.

The ith consumer can then choose a vehicle that embodies precisely his preferences. A lowlier ranked vehicle that can be purchased at lower price than his aspirational choice may then well be chosen.

The consumer/user is then able, (putting computational issues aside) to vary any one of the set of n computed optimal weight aⱼ₁ⁱ=bⱼⁱ+q*₁ⁱ coefficients up or down by a proportionate amount, say 10%, and redo the rankings. Suppose for simplicity the user can only upgrade specific weights one at a time, for (say) ‘safety’ and ‘performance’. For any one of these variations another ranking of advertisements with higher scores for items containing more of that attribute would come up and the same process recommences all over again. As a further variant, the user can set some attribute levels that he or she has no interest in to zero and redo the rankings.

There are several benefits to the choice engine approach which include the following:
1) The first is that the user need not specify his or her preferences or optimal weights. It can all be done for him/her automatically and, indeed, the user need not see the scoring system. This is also true when preference weights are simply coded low, medium or high.
2) Secondly, once computed (ideally pre-specified for all advertisements in advance) the user need not see the score, only the rankings.
3) Thirdly, since the user need not specify or observe the preference weights, it is not necessary to artificially limit the number that is computed to a mere handful. It is possible to have tens if not hundreds of attributes computed and included in the regression equation(s).
4) Fourthly, if the user is not fully satisfied with any of the (say) top ten items satisfying his budget constraint brought to the top of the list he/she can click on one of these and begin all over again. The (say) ten closest to this item will now come up and this process can continue until the user is fully satisfied with his or her choice.
5) Fifthly, if the user wishes to have more of some attribute such as safety once (say) the top ten list has come up on clicking on the preferred item, then he/she simply clicks on a box labelled ‘safety’. The user weight for safety, a_{S1}ⁱ=b_{S}ⁱ+q*_{S}ⁱ, is now raised by say 10% and a new ranking of items comes up with higher preferences for safety.
6) Sixthly, clicking on the label, ‘safety’, can in principle bring up a number of different characterisations of ‘safety’, ability to avoid accidents, survivability in the event of a crash, and so on. Having menus of this type enables inclusion of many variables grouped under menu headings in the analysis.
7) Seventhly, most of the processing required is pre-processing, in that most of the information required can be processed prior to an advertisement being displayed.

Before carrying out any of the above analysis the user 703 needs to be able to specify both the class of vehicle and body type required. This takes place automatically when the user clicks on his/her initial preferred choice that specifies both vehicle classification and body type. Searching (in the form of the (say) top ten related items automatically generated) typically is performed after these filters have been applied.

The utility score is really a net utility score as it is expressed in the form of the consumer's ‘surplus’, that is, net of the user's outlay or asking price from the classified advertisement. These summed squared attribute scores divided by two are in fact triangular consumer surplus measures computed for each attribute making up an item that can be considered by a given consumer or user.

When the user is asked to indicate preference weights by clicking a mouse on pre-specified values of the vector, aⱼ₁ⁱ, the expression, equation (15), forms the basis for scoring and ranking each item (vehicle in this example). Substituting the user-supplied preference weights aⱼⁱ into equation (15) yields the simplified quadratic specification as follows:

$${u}^{i} = {y}^{i} + {a}_{0}^{i} - {b}_{0} - ɛ + ( {a}_{1}^{i} - {b}_{1} - \frac{1}{2} {q}_{1} ) {q}_{1} + … + ( {a}_{n }^{i} - {b}_{n} - \frac{1}{2} {q}_{n} ) {q}_{n} , \qquad ( 26 )$$

that can be evaluated for each individual item by plugging in the attribute scores, q₁,q₂, . . . ,qₙ, for that item. When the scores differ from the optimal values given by q*ⱼⁱ=aⱼ₁ⁱ−bⱼ from equation (20), lower ranked items are identified.

It is apparent that implementing the ranking of items based on equation (26) is computationally intensive. This computational complexity can, unless sufficient computing power is provided, lead to slow system response which could reduce the incentive of the user 703 to make use of the disclosed choice engine arrangements. This potential problem can be addressed by pre-processing the specific comprehensive choice data 724 as described in relation to FIG. 6. Even the pre-processing approach is typically not implemented for each possible combination of the relative subjective utility weights aⱼⁱ and preferably, only a limited set of permitted customization weight permutations are used in the pre-processing.

By way of a numerical example, the user wishes to purchase a vehicle costing no more than (say) $25,000 within a particular vehicle segment. A regression of two preference factors, ‘safety’, S, and ‘performance’, P, on the prices of all new and secondhand vehicles in this segment expressed in $1,000s results in shadow price (marginal cost) coefficient estimates of (say):

p(q₁,q₂)=18.3+0.7q_{S}+0.4qₚ. (27)

Here the coefficient 0.7 is the shadow price of safety and 0.4 the shadow price of performance. If this user indicates a preference weight for safety of a_{S}ⁱ=5.7 and a preference weight for performance of a_{P}ⁱ=8.4, plugging these values into equation (20) yields an optimal score of 5.7−0.7=5 for safety and 8.4−0.4=8 for performance.

Plugging the scores for safety and performance into equation (27) yields a predicted price of 18.3+0.7×5+0.4×8=25, or $25,000. Evaluating equation (26) for a var vehicles with the sum of unobservable values yⁱ+a₀ⁱ set arbitrarily to zero yields a range of utility scores with a maximum value of −18.3+0.5×5²+0.5×8²=29.2, computed from either equation (25) or equation (26). Recall that in the actual price regressions, the prices and the attribute quantities would all be normalised on the zero to one range.

Hence the most desirable vehicle heading the list for this consumer has 5 units of safety, 8 units of performance, a utility score of 29.2 and an ask price of $25,000. Only vehicles with an ask price of $25,000 or less appear in the list and all the other vehicles appearing on the ranked list have utility scores of less than 29.2.

Suppose by way of example that another model has 7 units of safety but only 4.5 units of performance. Once again, this vehicle also satisfies the desired outlay of $25,000 as follows:

18.3+0.7×7+0.4×4.5=25,

but the level of wellbeing or utility is lower as follows:

−18.3+(5−0.5×7)×7+(4.5−0.5×4.5)×4.5=18.075<29.2.

In summary, quantities and shadow prices of each attribute computed in the steps 803 and 806 of FIG. 8 respectively are inputted into the scoring system processes 604, 402 in FIGS. 5, 6 respectively, based on consumer utility maximisation of his or her choices over attributes subject to an overall budget constraint and made up of the products of attribute quantities and shadow prices. It is optional for the user to provide actual information on his or her overall budget constraint or even an indicative price range for the item in question. The user may indicate the nature of his or her preferences. This can take the form of subjective preference weights which are entered via a simple system or simply by clicking the mouse on a displayed vehicle. The choice engine arrangement responds with a ranking of the items in question, for example, on line classified motor vehicle advertisements, satisfying by giving the specified subjective weighting to the user preferences inclusive of the estimated shadow prices.

The user can either call the seller directly or the seller can be sent an email providing the prospective buyer's offer. The offer to buy can be placed in an online auction mechanism to which sellers also place items for sale on a limit order basis with a commission payable for a successful sale. A commission can also be paid by the seller for the scoring of his item for sale/auction and the prospective buyer might also pay a commission for use of the choice engine.

The proposed choice engine arrangements in the automotive example have so far been directed so as to provide an optimal ranking of items for users who are prospective buyers. However, the utility scoring mechanisms for the consumer and prospective buyer provided by equations (25) and (26) for the optimal item and all items, respectively, can be equally valuable for a prospective seller or vendor. For example, if a seller (726) wishes his or her item to be ranked the highest by a particular class of buyer, it is a relatively simple matter to solve equation (25) for the residual regression term, ε, which is the difference between the ask price for the item and the price predicted by the regression equation (8). Thus it is possible to solve the relationship to find the seller's price discount which will give the item the highest ranking for a seller with given preferences.

The way that the choice engine mechanism is altered from one that ranks items with ask prices from the perspective of the buyer's preferences to one which determines seller ask prices that are optimal from the sellers perspective is along the following lines. The vendor (726) specifies a candidate item for sale but no longer specifies an ask price. Instead he or she specifies a target market for that item and a specified rank in that target market. For example, the candidate item might be a two year old Toyota Camry®. The specified market might be the collection of prospective buyers for a Toyota Camry® that is one or two years old. The preferences that will make such a vehicle ranked number 1, ie., optimal from the perspective of prospective buyers of such a vehicle, can be found by solving for the set of optimal preference weights using equation (21) and the attribute scores and estimated shadow prices for a two year old Toyota Camry®. The steps required to obtain the set of optimal preference weights goes through the same steps as in FIG. 9 except that the ask price is not inputted by the vendor at the outset.

The value of the ask price that will give the vendor's vehicle the desired highest rank is given by:

p^{Ask Rank1}≦p^{Predicted}+ε* (28)

where p^{Ask Rank1} is the upper bound for the required optimum ask price to gain the highest ranking for an item with the specified attributes, p^{Predicted} is the predicted price for the item based on the regression equation (8) and ε* is the optimal residual from the regression equation and is given by the following expression:

$${ɛ}^{*} = {y}^{i} + {a}_{0}^{i} - {b}_{0} - {u}^{* i} + \frac{1}{2} ( {q}_{1}^{* 2} + {q}_{2}^{* 2} + … + {q}_{n}^{* 2} ) , \qquad ( 29 )$$

which has been derived from equation (25) above and will typically be negative. If some lower rank rather than the top rank is required then the ask price will be higher and can be found by solving equation (26) for the optimal residual value once the desired ranking has been specified. If a desired rank is requested for a broader class of item than the specific item that the ask price has been requested for, then average attribute scores for that class of item can be used in place of the actual attribute scores for that item when evaluating equations (25) or (29).

The advantage that would be obtained by a seller providing more information in an advertisement, when prospective buyers have a high expressed preference for transparency and more information, can also be provided in the form of the higher ranking that a more informative advertisement would obtain.

Not only can one invert (reverse engineer) the scoring mechanism derived for the choice engine to assist the seller attract an appropriate prospective buyer, but the choice engine mechanisms can directly assist sellers to target particular buyers. For example, the generic data might consist of the expenditure patterns and socioeconomic and demographic features of population segments. From this data attributes of prospective buyers, a variety of “prospective buyer” propensities, can be created and scored. Seller utility scores and rankings can now be created utilising equation (26) based on preference weights for different prospective buyer attributes such as past purchases of similar items, distance from the seller, age category, gender, income, willingness of the prospective buyer to provide his or her own preferences, provide his or her own condition scoring if the item is in an accessible location, place a deposit on the item, etc.

Just as the disclosed choice engine arrangements can be used to assist the direct seller or vendor (726) find a willing buyer, set an appropriate ask price and better design the contents of an advertisement, these arrangements can also provide a great deal of useful information to designers, manufacturers, importers and distributors of items. By recording and storing the information provided by users of the choice engine on their preferences for all the attributes (step 303 of FIG. 4) and the shadow prices estimated in step 806 of FIG. 8, all the above groups can be assisted in redesigning the item in question so as to obtain a higher utility score from the choice engine (step 909 of FIG. 9 and equation (26)). With a better product or service, designers, manufacturers, importers, etc. can better serve the interests of consumers while at the same time earning higher profits.

### INDUSTRIAL APPLICABILITY

It is apparent from the above that the arrangements described are applicable to the data processing industry.

The foregoing describes only some embodiments of the present invention, and modifications and/or changes can be made thereto without departing from the scope and spirit of the invention, the embodiments being illustrative and not restrictive.

The principles of the preferred method described herein have general applicability to Internet based choice engines, although the possible applications are not limited to this type of arrangement. However, for ease of explanation, the steps of the preferred method are described with reference to selection of motor vehicles. However, it is not intended that the present invention be limited to the described method. Accordingly, the disclosed choice engine arrangements can be applied to selection of candidate real estate properties, motor vehicles, and a plethora of other goods and services.

APPENDIX A
An example of attribute input data items (derived
from directly observable feature data).

| | Car No. 1 | Car No. 2 | Car No. 3 |
|---|---|---|---|
| Age (months) | 0 | 12 | 24 |
| Odometer (km) | 0 | 10,000 | 20,000 |
| New Price ($′000) | 35 | 22 | 16 |
| Four-wheel disk | Yes | Yes | No |
| brakes | | | |
| ABS brakes | Yes | No | No |

APPENDIX B
An example of personal weights relating to an item of interest,
the associated attributes and the estimated shadow prices.

| Attribute | Weight | Shadow Price Estimate |
|---|---|---|
| Safety | 0.7143 | 0.7 |
| Performance | 20 | 0.4 |

APPENDIX C
An example of ranked choice data (budget limit is $300 per week).

| Car No. | Suggested Price |
|---|---|
| 17 | $19,800 |
| 23 | $17,000 |
| 84 | $16,900 |

### Appendix D

### Alternative Scoring Method

In an alternative specification, a simple example is one in which attributes are those things qⱼⁱ of value on which the user denoted by superscript i is prepared to spend a proportion aⱼⁱ of his or her budget for the item given by its price, p(q₁,q₂, . . . ,qₙ), where p(q₁,q₂, . . . ,qₙ) is the dollar amount that the person wishes to spend on the item in question. Thus if ‘objective’ shadow price coefficient estimates bᵢ to bₙ are treated in a simple linear fashion (and they can be treated in more complex manners) then the total dollar expenditure on the ith attribute is αⱼⁱp(q₁,q₂, . . . ,qₙ), where aⱼⁱ is the subjective budget weight provided by that user. This dollar amount is given by the product of the jth estimated shadow price bⱼ and the quantity index for the jth attribute that is optimal for that user, q*ⱼⁱ, to yield αⱼⁱp(q₁, . . . ,qₙ)=bⱼq*ⱼⁱ. Equivalently, the budget share,

$${α}_{j}^{i} = \frac{{b}_{j} {q}_{j}^{* i}}{p ( . )} ,$$

where αⱼⁱ and p(q₁,q₂, . . . ,qₙ) have been specified by the user, the shadow price, bⱼ, has been estimated and therefore the particular qⱼⁱ=q*ⱼⁱ value is optimal from the perspective of that user.

Determination of utility scores, referred to in the steps 604 (FIG. 5), 402 (FIG. 6), and 400 (FIGS. 6 and 7) can, in an alternative example, be performed as described below.

The aforementioned steps use a scoring system also based on consumer utility maximisation. In one example, this is determined using regression analysis based on a linear specification of the attributes q₁ to qₙ being, as determined in the step 803 of FIG. 8, (a) ‘safety’, (b) ‘luxury’, (c) ‘performance’, (d) ‘green’ (environmentally friendly), (e) ‘space’, (f) ‘city’, (g) ‘towing’, (h) ‘economy’, and (i) ‘offroad’.

The expenditure, price, or outlay regression becomes in linear form (noting that it need not be linear so long as an optimal solution exists):

p=b₀+b₁q₁+b₂q₂+b₃q₃+b₄q₄+ . . . +bₙqₙ+ε (A.1)

where:
p is the outlay in dollars on the item in question, for example, the price of each make, model and vintage of motor vehicle;
q₁ to qₙ are the quantities of the attributes defined in the step 803 in FIG. 8 for each item;
n is the number of attributes;
   qⱼ is the quantity of the jth factor (ie., attribute);
ε is normally distributed error term with an expected value of zero; and
b₁ to bₙ are the estimated coefficients from the regression which are interpreted as shadow prices or marginal costs, with b₀, the “constant” term or unexplained portion of the outlay per unit time period.

The regression equation can be re-written as the budget or technology constraint net of the fixed outlay as the following relationship: p−b₀=b₁q₁+b₂q₂+ . . . +bₙqₙ is the net or ‘explained’ budget outlay,

where:

b₀ is the constant term in the regression equation and expresses an expense such as vehicle registration that has to be incurred under all circumstances; and the shadow price of the j^{th} attribute, denoting one of the attributes, 1 to n, with attribute scores, q₁ to qₙ, is denoted by bⱼ.

In the simplest case the utility u to the consumer (choice engine user 703) can be expressed in terms of a utility objective function that uses the aforementioned predefined factors, qⱼ, as a multiplicative index of the “good” attributes for the item of interest (eg., the motor vehicle) with constant additive weights expressed as powers as follows:

u=q₁^{α}^{₁}q₂^{α}^{₂} . . . qₙ^{α}^{ₙ}, (A.2)

where αⱼⁱ are the personal preference weights that in this alternative configuration can be provided by the user 703 denoted by i in the step 303 in FIG. 4. Each weight aⱼⁱ representing by assumption the proportion of the consumer's budget for the item he or she is willing to spend on the j^{th} attribute of quantity, qⱼ, such that the sum,

$${\sum }_{j = 1}^{n} {α}_{j}^{i} = 1.$$

Note that some of the weights can be specified to be zero, in which case that attribute does not enter into the choice of vehicle. Typically, an equation expressed in terms of powers can be used score individual items or vehicles in this alternative formulation.

As described in relation to the step 303 in FIG. 4, the user needs to specify his own set of weights, αⱼⁱ, for j=1, 2, . . . , n. If the specific comprehensive choice data 724 is pre-processed (according to the process of FIG. 6), this is equivalent to choosing a particular set of weights αⱼⁱ already included in the specific comprehensive choice data 724. Thus, in one arrangement, predetermined weights αⱼⁱ can be presented to the user on the display 202 by the choice server 107 (see FIG. 3) and the user 703 is required to choose one of the displayed sets of pre-defined weights. In another (pre-processed) arrangement, the user can input their desired weights αⱼⁱ however the system 200 will select the closest set of predefined weights in the predetermined specific comprehensive choice data 724. If, for example, the user is safety conscious, his or her specification of the weight αⱼⁱ representing safety will be large relative to the weights assigned to the attributes of luxury, prestige and the other attributes.

Maximising the power utility objective, equation (A.2) by the kth consumer, subject to the budget or technology constraint specified in terms of the set of estimated shadow prices, p^{k}=b₀+b₁q₁^{k}+b₂q₂^{k} + . . . +bₙqₙ^{k}, from equation (A.1), where superscript k denotes the consumer's given desired budget for the item, p^{k}, and qⱼ^{k} denotes the quantities of the attributes to be chosen, yields, in regard to any particular attribute qⱼ, the condition that the marginal rate of substitution in consumption of the attribute, qⱼ, is equal to the product of the relative alpha preference share weights and the estimated shadow price ratio. Hence the relative choice of the attribute is characterised by the following relationship:

$$\frac{{q}_{i}^{k}}{{q}_{j}^{k}} = \frac{{α}_{i}^{k}}{{α}_{j}^{k}} \frac{{b}_{j}}{{b}_{i}} for all consumers , k , and attributes i and j , i \neq j .$$

In this alternative approach the above equation represents a set of n−1 simultaneous equations if there are n attributes. Solving these equations subject to the budget constraint, representing the maximum outlay on the item, yields optimal attribute demands for the kth consumer, which depend positively on the residual budget, p^{k}−b₀, the subjective expenditure share weight provided by the consumer, αⱼ^{k}, and the inverse of “shadow price”, bⱼ, as follows:

$${q}_{j}^{* k} = \frac{{α}_{j}^{k} ( {p}^{k} - {b}_{0} )}{{b}_{j}} for all j ( j = 1 , … , n ) ,$$

where p^{k}−b₀ is portion of the outlay for the kth consumer explained by the price regression equation and, as before, p^{k} is the price or “user-cost” of the item (ie., the budget limit that can be set by the user in the step 303 in FIG. 4), and p−b₀ is the residual amount of the outlay after taking account of fixed and unaccounted for outlays.

The above equation shows how the optimum quantity of each attribute is chosen by the kth consumer with a given budget constraint in this alternative specification. It would be possible to simply search across all items until the one most closely matching the optimum specification, set of qⱼ, (j=1, . . . ,n), across all the attributes with a positive alpha weight, is found for a consumer of that type with a given budget.

Substituting the optimal quantities of the attributes for the kth consumer into the power utility function, yields the optimal and hence maximal utility achievable by that consumer with those expressed preferences and budget allocation, given by

u*ₒₚₜᵢₘᵤₘ^{k}=(p^{k}−b₀)Kb₁^{-α}^{₁}^{^{k}}b₂^{-α}^{₂}^{^{k}} . . . . bₙ^{-α}^{ₙ}^{^{k}}, (A.3)

where the constant K=(α₁^{k})^{α}^{₁}^{^{k}}(α₂^{k})^{α}^{₂}^{^{k}} . . . (αₙ^{k})^{α}^{ₙ}^{^{k}}. The utility score depends on the consumer's budget, the set of estimated shadow prices for which the consumer has indicated a positive weight, αⱼ^{k}, for that attribute and the set of alpha weights which are positive. The item which is optimal for this consumer with this budget is the one which has been scored with this utility level. Since the final equation refers only to the optimal score given the budget and preferences, it cannot be used to score items directly. The utility score given by this equation can only be attached to the item that precisely matches the consumer's preferences and budget.

For a given specified budget or prospective outlay p^{k} and in the described example, the disclosed choice engine uses equation (A.2) to rank all the vehicles or all the items satisfying the budget condition p^{k}, starting from the highest utility score given by the final equation and working downwards. The highest ranked vehicle is the preferred choice. The item or vehicle which is optimal from the perspective of the power utility equation will have the specified utility score given by the final equation, equation (A.3).

1. A method of identifying a desired item from a set of candidate items each associated with at least one of directly observable factors, and intangible factors that indirectly reflect said directly observable factors, the method comprising the steps of:
constructing, from the associated factors, attributes which characterise the candidate items;
assigning the amount of each attribute preferred by a user;
estimating the amount of each attribute associated with each of the items;
determining the marginal cost of the attributes;
determining the extent to which each candidate item provides the amount of each attribute required by the user; and
constructing a list of at least some of the candidate items in an order that reflects how each said candidate item in the list satisfies the users preferences subject to the assigned preferences of the user, and given the marginal cost of the attributes, wherein the desired item is an item in the ordered list.

2. A method according to claim 1, comprising a farther step of specifying a user budget for the desired item, and wherein the step of constructing the list of ordered candidate items is dependent upon the specified user budget.

3. A method according to claim 2, comprising a further step of selecting, from the ordered list, the item which provides for the optimal combination and levels of attributes given the consumer's preferences and the estimated marginal costs to the consumer of the attributes in question and budget.

4. A method according to claim 1, comprising the further steps of:
matching a set of available items against the list of candidate items;
if an available item matches a candidate item in the list, specifying the matching available item as the desired item; and
if none of the available items match a candidate item in the list, generating a request for the desired item said request including at least some of said attributes and the amount of each attribute preferred by the user.

5. A method according to claim 1, wherein:
the associated factors are one of internal factors possessed by the candidate items, and external factors relating to how the candidate items are offered for sale; and
the corresponding constructed attributes are one of internal attributes possessed by the candidate items, and external attributes relating to the manner in which the candidate items are offered for sale.

6. A method according to claim 5 wherein:
the manner in which the candidate items are offered for sale includes placing advertisements for the candidate items; and
the associated external factor relates to the amount of information provided in the advertisement.

7. A method according to claim 1, wherein the intangible factors include a report on the condition of a candidate item by the user.

8. A method according to claim 1, comprising the further steps of:
storing information about the amount of each attribute preferred by the user; and
presenting the stored information to another user prior to the assigning step.

9. A method according to claim 1, wherein the marginal costs of the attributes is zero.

10. A method according to claim 1, comprising the further steps of:
matching a set of available items against the list of candidate items;
constructing a list of at least some of the available items in an order that reflects how each said available item in the list satisfies the users preferences subject to the assigned preferences of the user, and given the marginal cost of the attributes.

11. A method of determining an ask price for an item to be sold, said item being an available member of a set of candidate items each associated with at least one of directly observable factors, and intangible factors that indirectly reflect said directly observable factors, the method comprising the steps of:
constructing, from the associated factors, attributes which characterise the set of candidate items;
estimating the amount of each attribute associated with each of the candidate items;
determining the marginal cost of the attributes associated with each of the candidate items;
specifying one of (a) the item to be sold and (b) said at least one of directly observable factors, and intangible factors associated with the item to be sold;
if the item to be sold is specified, determining said at least one of directly observable factors, and intangible factors associated with the item to be sold;
constructing, from the factors associated with the item to be sold, attributes other than ask price which characterise the item to be sold;
specifying (a) a sub-set of the candidate items in regard to which a desired rank is to be determined, and (b) a desired rank of the item to be sold in regard to the specified sub-set;
determining the ask price at which the item to be sold should be offered for sale, dependent upon the constructed attributes which characterise the item to be sold, the specified sub-set of candidate items, the specified rank of the item to be sold, and the extent to which each candidate item provides the amount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.

12. An apparatus for identifying a desired item from a set of candidate items each associated with at least one of directly observable factors, and intangible factors that indirectly reflect said directly observable factors, the apparatus comprising:
means for constructing, from the associated factors, attributes which characterise the candidate items;
means for assigning the amount of each attribute preferred by a user;
means for estimating the amount of each attribute associated with each of the items;
means for determining the marginal cost of the attributes;
means for determining the extent to which each candidate item provides the amount of each attribute required by the user; and
means for constructing a list of at least some of the candidate items in an order that reflects how each said candidate item in the list satisfies the users preferences subject to the assigned preferences of the user, and given the marginal cost of the attributes, wherein the desired item is an item in the ordered list.

13. An apparatus for determining an ask price for an item to be sold, said item being an available member of a set of candidate items each associated with at least one of directly observable factors, and intangible factors that indirectly reflect said directly observable factors, the apparatus comprising:
means for constructing, from the associated factors, attributes which characterise the set of candidate items;
means for estimating the amount of each attribute associated with each of the candidate items;
means for determining the marginal cost of the attributes associated with each of the candidate items;
means for specifying one of (a) the item to be sold and (b) said at least one of directly observable factors, and intangible factors associated with the item to be sold;
means, if the item to be sold is specified, for determining said at least one of directly observable factors, and intangible factors associated with the item to be sold;
means for constructing, from the factors associated with the item to be sold, attributes other than ask price which characterise the item to be sold;
means for specifying (a) a sub-set of the candidate items in regard to which a desired rank is to be determined, and (b) a desired rank of the item to be sold in regard to the specified sub-set;
means for determining the ask price at which the item to be sold should be offered for sale, dependent upon the constructed attributes which characterise the item to be sold, the specified sub-set of candidate items, the specified rank of the item to be sold, and the extent to which each candidate item provides the amount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.

14. An apparatus for identifying a desired item from a set of candidate items each associated with at least one of directly observable factors, and intangible factors that indirectly reflect said directly observable factors, the apparatus comprising:
a memory for storing a program; and
a processor for executing the program, said program comprising:
code for constructing, from the associated factors, attributes which characterise the candidate items;
code for assigning the amount of each attribute preferred by a user;
code for estimating the amount of each attribute associated with each of the items;
code for determining the marginal cost of the attributes;
code for determining the extent to which each candidate item provides the amount of each attribute required by the user; and
code for constructing a list of at least some of the candidate items in an order that reflects how each said candidate item in the list satisfies the users preferences subject to the assigned preferences of the user, and given the marginal cost of the attributes, wherein the desired item is an item in the ordered list.

15. An apparatus for determining an ask price for an item to be sold, said item being an available member of a set of candidate items each associated with at least one of directly observable factors, and intangible factors that indirectly reflect said directly observable factors, the apparatus comprising:
a memory for storing a program; and
a processor for executing the program, said program comprising:
code for constructing, from the associated factors, attributes which characterise the set of candidate items;
code for estimating the amount of each attribute associated with each of the candidate items;
code for determining the marginal cost of the attributes associated with each of the candidate items;
code for specifying one of (a) the item to be sold and (b) said at least one of directly observable factors, and intangible factors associated with the item to be sold;
code, if the item to be sold is specified, for determining said at least one of directly observable factors, and intangible factors associated with the item to be sold;
code for constructing, from the factors associated with the item to be sold, attributes other than ask price which characterise the item to be sold;
code for specifying (a) a sub-set of the candidate items in regard to which a desired rank is to be determined, and (b) a desired rank of the item to be sold in regard to the specified sub-set;
code for determining the ask price at which the item to be sold should be offered for sale, dependent upon the constructed attributes which characterise the item to be sold, the specified sub-set of candidate items, the specified rank of the item to be sold, and the extent to which each candidate item provides the amount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.

16. A computer program product including a computer readable medium having recorded thereon a computer program for directing a processor to execute a method for identifying a desired item from a set of candidate items each associated with at least one of directly observable factors, and intangible factors that indirectly reflect said directly observable factors, the program comprising:
code for constructing, from the associated factors, attributes which characterise the candidate items;
code for assigning the amount of each attribute preferred by a user;
code for estimating the amount of each attribute associated with each of the items;
code for determining the marginal cost of the attributes;
code for determining the extent to which each candidate item provides the amount of each attribute required by the user; and
code for constructing a list of at least some of the candidate items in an order that reflects how each said candidate item in the list satisfies the users preferences subject to the assigned preferences of the user, and given the marginal cost of the attributes, wherein the desired item is an item in the ordered list.

17. A computer program product including a computer readable medium having recorded thereon a computer program for directing a processor to execute a method for determining an ask price for an item to be sold, said item being an available member of a set of candidate items each associated with at least one of directly observable factors, and intangible factors that indirectly reflect said directly observable factors, the program comprising:
code for constructing, from the associated factors, attributes which characterise the set of candidate items;
code for estimating the amount of each attribute associated with each of the candidate items;
code for determining the marginal cost of the attributes associated with each of the candidate items;
code for specifying one of (a) the item to be sold and (b) said at least one of directly observable factors, and intangible factors associated with the item to be sold;
code, if the item to be sold is specified, for determining said at least one of directly observable factors, and intangible factors associated with the item to be sold;
code for constructing, from the factors associated with the item to be sold, attributes other than ask price which characterise the item to be sold;
code for specifying (a) a sub-set of the candidate items in regard to which a desired rank is to be determined, and (b) a desired rank of the item to be sold in regard to the specified sub-set;
code for determining the ask price at which the item to be sold should be offered for sale, dependent upon the constructed attributes which characterise the item to be sold, the specified sub-set of candidate items, the specified rank of the item to be sold, and the extent to which each candidate item provides the amount of each attribute which characterise the item to be sold; wherein said determined ask price causes the item to be sold to have the desired rank in an ordered list of at least some of the sub-set of candidate items, said list having an order that reflects how each said candidate item in the list satisfies users preferences subject to assigned preferences of a user, and given the marginal cost of the attributes, wherein the item to be sold is an item in the ordered list.
